(19) United States
(12) Patent Application Publication
(10) Pub. No.: US 2026/0371256 A1
(43) Pub. Date: Nov. 19, 2026

(54) MAXIMUM POWER REDUCTION FOR WIRELESS COMMUNICATIONS

(71) Applicant: Lenovo (United States) Inc., Morrisville, NC (US)

(72) Inventor: Colin Frank, Park Ridge, IL (US)

(73) Assignee: Lenovo (United States) Inc., Morrisville, NC (US)

(21) Appl. No.: 19/355,769

(22) Filed: Oct. 10, 2025

(51) Int. Cl. H04W 52/06

(52) U.S. Cl. CPC H04W 52/06

(57) ABSTRACT

Various aspects of the present disclosure relate to maximum power reduction (MPR) for wireless communications. A user equipment (UE) may receive signaling from a network equipment (NE) that indicates a time-frequency resource allocation, such as a resource block (RB) allocation, for an uplink transmission. The UE may determine an MPR for a maximum transmit power for the uplink transmission based on an overlap between the time-frequency resource allocation and an in-phase/quadrature (I/Q) image associated with the uplink transmission. The UE may select the maximum transmit power based on the MPR for the uplink transmission. The UE may transmit the uplink transmission to the NE using a transmit power that is less than or equal to the maximum transmit power.

### TECHNICAL FIELD

The present disclosure relates to wireless communications, and more specifically to transmit power control for wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive signaling that indicates a time-frequency resource allocation associated with an uplink transmission, where a maximum power reduction (MPR) associated with the uplink transmission is based on an overlap between the time-frequency resource allocation and an in-phase/quadrature (I/Q) image associated with the uplink transmission, select, based on the MPR, a maximum transmit power for the uplink transmission, and transmit the uplink transmission using a transmit power that is based on the maximum transmit power.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a time-frequency resource allocation associated with an uplink transmission, where an MPR associated with the uplink transmission is based on an overlap between the time-frequency resource allocation and an I/Q image associated with the uplink transmission, select, based on the MPR, a maximum transmit power for the uplink transmission, and transmit the uplink transmission using a transmit power that is based on the maximum transmit power.

A method performed or performable by a UE for wireless communication is described. The method may include receiving signaling that indicates a time-frequency resource allocation associated with an uplink transmission, where an MPR associated with the uplink transmission is based on an overlap between the time-frequency resource allocation and an I/Q image associated with the uplink transmission, selecting, based on the MPR, a maximum transmit power for the uplink transmission, and transmitting the uplink transmission using a transmit power that is based on the maximum transmit power.

In some implementations of the UE, the processor, and the method described herein, the uplink transmission satisfies one or more emission criterion based on the MPR, where the one or more emission criterion include one or more of an error vector magnitude (EVM), an adjacent channel leakage ratio (ACLR), a spectral emissions mask (SEM), a spurious emission, or an in-band emission. In some implementations of the UE, the processor, and the method described herein, a modulation and coding scheme (MCS) corresponding to the time-frequency resource allocation is based on the MPR. In some implementations of the UE, the processor, and the method described herein, the UE, the processor, and the method may further be configured to, capable of, or operable to apply a modulation type to the uplink transmission, where the modulation type includes 64-quadrature amplitude modulation (QAM) or 256-QAM. In some implementations of the UE, the processor, and the method described herein, the time-frequency resource allocation overlaps with the I/Q image based on a frequency corresponding to a local oscillator (LO), and the time-frequency resource allocation includes at least one of one or more first resource blocks (RBs) that do not overlap with the I/Q image, one or more second RBs that partially overlap with the I/Q image, or one or more third RBs that overlap with the I/Q image. In some implementations of the UE, the processor, and the method described herein, the UE, the processor, and the method may further be configured to, capable of, or operable to receive additional signaling that indicates at least one lookup table including a set of MPRs including the MPR, where respective MPRs of the set of MPRs correspond to the one or more first RBs, the one or more second RBs, or the one or more third RBs. In some implementations of the UE, the processor, and the method described herein, the time-frequency resource allocation includes at least one of inner RBs, outer RBs, or edge RBs.

In some implementations of the UE, the processor, and the method described herein, the UE, the processor, and the method may further be configured to, capable of, or operable to receive additional signaling that indicates an update to a frequency corresponding to an LO, and adjust, based on the update to the frequency corresponding to the LO, the frequency corresponding to the LO to reduce the overlap between the time-frequency resource allocation and the I/Q image. In some implementations of the UE, the processor, and the method described herein, the UE, the processor, and the method may further be configured to, capable of, or operable to transmit additional signaling that indicates a frequency corresponding to an LO, where the time-frequency resource allocation overlaps with the I/Q image based on the frequency corresponding to the LO, and the time-frequency resource allocation is based on reducing the overlap between the time-frequency resource allocation and the I/Q image.

An NE (e.g., a base station) for wireless communication is described. The NE may be configured to, capable of, or operable to perform one or more operations as described herein. For example, the NE may be configured to, capable of, or operable to transmit signaling that indicates a time-frequency resource allocation associated with an uplink transmission, where an MPR associated with the uplink transmission is based on an overlap between the time-frequency resource allocation and an I/Q image associated with the uplink transmission, and receive the uplink transmission using a transmit power that is based on a maximum transmit power, where the maximum transmit power is based on the MPR.

A processor (e.g., a standalone processor chipset, or a component of an NE) for wireless communication is described. The processor may be configured to, capable of, or operable to perform one or more operations as described herein. For example, the processor may be configured to, capable of, or operable to transmit signaling that indicates a time-frequency resource allocation associated with an uplink transmission, where an MPR associated with the uplink transmission is based on an overlap between the time-frequency resource allocation and an I/Q image associated with the uplink transmission, and receive the uplink transmission using a transmit power that is based on a maximum transmit power, where the maximum transmit power is based on the MPR.

A method performed or performable by an NE (e.g., a base station) for wireless communication is described. The method may include transmitting signaling that indicates a time-frequency resource allocation associated with an uplink transmission, where an MPR associated with the uplink transmission is based on an overlap between the time-frequency resource allocation and an I/Q image associated with the uplink transmission, and receiving the uplink transmission using a transmit power that is based on a maximum transmit power, where the maximum transmit power is based on the MPR.

In some implementations of the NE, the processor, and the method described herein, the uplink transmission satisfies one or more emission criterion based on the MPR, where the one or more emission criterion include one or more of an EVM, an ACLR, a SEM, a spurious emission, or an in-band emission. In some implementations of the UE, the processor, and the method described herein, the NE, the processor, and the method may further be configured to, capable of, or operable to select an MCS corresponding to the time-frequency resource allocation based on the MPR. In some implementations of the UE, the processor, and the method described herein, the uplink transmission is associated with a modulation type, and the modulation type includes 64-QAM or 256-QAM. In some implementations of the UE, the processor, and the method described herein, the time-frequency resource allocation overlaps with the I/Q image based on a frequency corresponding to an LO, and the time-frequency resource allocation includes at least one of one or more first RBs that do not overlap with the I/Q image, one or more second RBs that partially overlap with the I/Q image, or one or more third RBs that overlap with the I/Q image. In some implementations of the UE, the processor, and the method described herein, the NE, the processor, and the method may further be configured to, capable of, or operable to transmit additional signaling that indicates at least one lookup table including a set of MPRs including the MPR, where respective MPRs of the set of MPRs correspond to the one or more first RBs, the one or more second RBs, or the one or more third RBs. In some implementations of the UE, the processor, and the method described herein, the time-frequency resource allocation includes at least one of inner RBs, outer RBs, or edge RBs.

In some implementations of the UE, the processor, and the method described herein, the NE, the processor, and the method may further be configured to, capable of, or operable to transmit additional signaling that indicates an update to a frequency corresponding to an LO to reduce the overlap between the time-frequency resource allocation and the I/Q image. In some implementations of the UE, the processor, and the method described herein, the NE, the processor, and the method may further be configured to, capable of, or operable to receive additional signaling that indicates a frequency corresponding to an LO, where the time-frequency resource allocation overlaps with the I/Q image based on the frequency corresponding to the LO, and select the time-frequency resource allocation based on reducing the overlap between the time-frequency resource allocation and the I/Q image.

### BRIEF DESCRIPTION OF THE DRAWINGS

FIG. 1 illustrates an example of a wireless communications system in accordance with aspects of the present disclosure.

FIGS. 2 and 3 illustrate examples of resource diagrams, in accordance with aspects of the present disclosure.

FIG. 4 illustrates an example of a wireless communications system, in accordance with aspects of the present disclosure.

FIG. 5 illustrates an example of a resource diagram, in accordance with aspects of the present disclosure.

FIG. 6 illustrates an example of a signaling diagram, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling using various modulation types, also referred to as modulation schemes, and transmit power levels. Higher order modulation types, such as 64-QAM and 256-QAM, may enable increased data throughput by encoding more bits per symbol compared to lower order modulation types, such as quadrature phase shift keying (QPSK) or 16-QAM. The higher order modulation types may have more stringent signal quality criterion to maintain error rates below a threshold, including lower average EVM thresholds. For example, 256-QAM may have an average EVM threshold of 3.5% or better, while QPSK may have an average EVM threshold of 17.5%. In some cases, a UE may implement MPR techniques that reduce transmit power to improve signal quality by operating power amplifiers in more linear regions, which may also reduce a coverage area and data rates for higher order modulation types.

In some examples, the MPR techniques may not account for interference patterns that affect higher order modulation types, including interference from I/Q image signals that appear at frequencies symmetrically opposite to desired signals relative to an LO frequency. If a resource allocation (e.g., time-frequency resources, including one or more RBs) overlaps with an I/Q image, then the interference may degrade signal quality, resulting in increased MPR to meet EVM thresholds and limiting the transmit power available for higher order modulation types. Increasing the MPR may reduce or prevent higher order modulation types from being used over portions of a cell coverage area, reducing potential throughput benefits that the higher order modulation types can provide. Additionally, or alternatively, MPR values may not vary between resource allocations that experience I/Q image interference and resource allocations that do not, potentially applying unnecessarily restrictive power reductions even when interference conditions may allow for higher transmit power levels.

As described herein, to improve transmit power efficiency for higher order modulation types, a UE may dynamically select an MPR based on whether a time-frequency resource allocation overlaps with a corresponding I/Q image relative to an LO frequency. The UE may receive signaling from an NE that indicates the time-frequency resource allocation for an uplink transmission and may determine an overlap between the resources in the time-frequency resource allocation (e.g., one or more RBs and/or REs within the RBs) and a corresponding I/Q image. The UE may apply different MPR values to a maximum transmit power for the uplink transmission depending on an extent of the overlap. For example, the UE may utilize a lower MPR value for higher order modulation types, including 64-QAM and 256-QAM, if the resource allocation does not overlap with the corresponding I/Q image. In some other examples, the UE may utilize a higher MPR value for the higher order modulation types if the resource allocation does overlap with the corresponding I/Q image. The UE may select a maximum transmit power based on the determined MPR and may transmit the uplink transmission using a transmit power that does not exceed the selected maximum transmit power, enabling higher transmit power levels when I/Q image interference is minimized, while maintaining compliance with emission criterion and signal quality thresholds.

By performing the described techniques, a device in a wireless communications system can provide for improved transmit power efficiency for higher order modulation types by dynamically adjusting an MPR based on I/Q image interference patterns. For example, a UE may enable higher transmit power levels for the higher order modulation types if resource allocations do not overlap with corresponding I/Q images, thereby expanding a coverage area in which the higher order modulation types can be utilized. Additionally, or alternatively, the UE may reduce unnecessary power back-off by differentiating between resource allocations that experience I/Q image interference and resource allocations that do not experience I/Q image interference. Additionally, or alternatively, the UE may enhance overall system throughput by enabling utilization of higher order modulation types across additional portions of cell coverage areas, as the MPR based on I/Q image interference patterns provides for increased transmit power without compromising signal quality or regulatory compliance.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

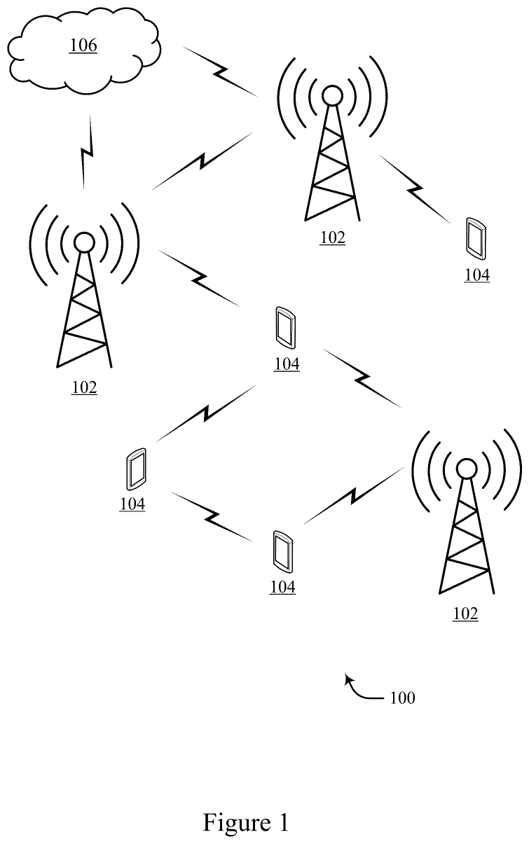

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), an NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kilohertz (kHz)) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexed (OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 megahertz (MHz)-7.125 Gigahertz (GHz)), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

One or more devices (UEs 104, NEs 102, including base stations and gNBs, etc.) in the wireless communications system 100 may support reception and/or transmission of wireless communication using time-frequency resources. For example, an NE 102 may transmit signaling (e.g., control signaling, including downlink control information (DCI), radio resource control (RRC) signaling, or MAC-control elements (MAC-CEs), among other types of control signaling) that indicates (e.g., configures, allocates, schedules) the time-frequency resources for an uplink transmission from the UE 104 to the NE 102 and/or for a downlink transmission from the NE 102 to the UE 104. The time-frequency resources can include, but are not limited to, one or more RBs, RB sets, frequency layers, and/or carrier frequencies for the UE 104 to use during uplink transmissions and/or downlink receptions. An RB is a unit of time-frequency resources that includes a set of subcarriers over a time duration, such as a slot or symbol. An RB can include one or more resource elements (REs), which are smaller units of time-frequency resources.

A UE 104 may include one or more transmitter components, also referred to as a transmit chain, that processes and prepares a signal for transmission. For example, the transmit chain may transform digital data into a radio frequency signal for transmission over a wireless medium. The transmit chain may include a digital signal processor (DSP) that may perform initial processing of digital data, such as error correction coding, interleaving, and digital filtering. The transmit chain may also include a modulator that may encode digital data onto a carrier signal by varying characteristics of the digital data, such as amplitude, phase, or frequency according to a selected modulation scheme. In some cases, the transmit chain may include a digital-to-analog converter (DAC) that may convert processed digital signals into analog signals. The transmit chain may also include an up-converter or mixer that may translate the baseband or intermediate frequency signal to the desired radio frequency carrier frequency for transmission. The transmit chain may also include one or more amplification stages. For example, the transmit chain may include a power amplifier that may amplify the radio frequency signal to achieve a transmit power level for wireless transmission. In some cases, the transmit chain may include additional amplification components, such as a driver amplifier that may provide intermediate amplification before the power amplifier. The transmit chain may include filtering components that may remove unwanted frequency components or harmonics from the transmitted signal. For example, the transmit chain may include bandpass filters, low-pass filters, or other filtering elements that may ensure the transmitted signal meets spectral criterion and reduces interference with other frequency bands. A transmit chain may include one or more additional, or alternative, components to those described herein.

The UE 104 may implement the transmitter to encode digital data onto frequency carrier waves by varying an amplitude, frequency, and/or phase, which is referred to as modulation. The UE 104 may utilize different modulation types, also referred to as modulation schemes, for encoding the digital data. The modulation types may include, but are not limited to, phase shift keying (PSK), frequency shift keying (FSK), amplitude shift keying (ASK), QAM (e.g., 16-QAM, 64-QAM, 256-QAM), binary phase shift keying (BPSK), or QPSK. For example, QAM may combine amplitude and phase modulation to encode multiple bits per symbol by varying both the amplitude and phase of the carrier signal according to a constellation pattern. A constellation pattern in QAM visually represents symbols of a signal as points on a two-dimensional (2D) grid (e.g., constellation diagram) with an in-phase axis and a quadrature axis, with a distance of respective points from an origin of the 2D grid showing amplitude and the angle showing phase. The in-phase axis may represent a real component of the signal, which corresponds to a cosine component of the carrier wave and represents the portion of the signal that is aligned with the reference carrier frequency. The quadrature axis may represent an imaginary component of the signal, which corresponds to a sine component of the carrier wave and represents the portion of the signal that is phase-shifted by 90 degrees relative to the reference carrier frequency. Both axes may be orthogonal to each other in the constellation diagram and together form a complex number representation, where the real component defines the horizontal coordinate and the imaginary component defines the vertical coordinate of each symbol point in the constellation pattern. A number of points in the grid indicates the number of bits per symbol, allowing for higher data rates by increasing the number of unique symbols in the pattern. For example, 256-QAM uses 256 different points in a constellation pattern to represent 8 bits per symbol, while 64-QAM uses 64 different points in a constellation pattern to represent 6 bits per symbol.

A UE 104 may utilize one or more metrics or evaluation criterion to evaluate a quality of a signal output from the transmit chain. For example, the UE 104 may evaluate an EVM, which represents a difference between an ideal and actual constellation points of a signal. The EVM may be a percentage value derived from a square root of an average of a square of a distance between the ideal and the actual constellation points. Additionally, or alternatively, the UE 104 may evaluate an ACLR, which is a ratio (e.g., in decibels (dB)) between a power transmitted in an assigned channel and a power that leaks into one or more neighboring channels. Additionally, or alternatively, the UE 104 may evaluate a SEM, which may specify maximum allowable power levels at various frequency offsets from a carrier frequency, typically expressed in dB relative to the in-band power. Additionally, or alternatively, the UE 104 may evaluate in-band emissions occurring within an allocated frequency band or channel bandwidth assigned to the UE 104 for transmission (e.g., as distinguished from out-of-band emissions that occur outside the allocated frequency range), including power transmitted in unallocated RBs, LO leakage, and/or I/Q image power on RBs symmetrically located relative to the LO frequency. The LO leakage may result from imperfect isolation between the LO and other components in the signal path, causing the LO frequency to be present in the transmitted or received signal. The I/Q image may appear at a frequency symmetrically opposite to a desired signal frequency relative to the LO frequency, resulting from imperfections in the in-phase and quadrature signal paths of a transmitter or receiver.

The metrics and/or evaluation criterion may vary for each modulation type. In some cases, higher order modulation schemes may have more stringent signal quality criterion compared to lower order modulation schemes. Higher order modulation schemes may refer to modulation schemes that encode greater than a threshold numerical quantity (e.g., number, amount) of bits per symbol, such as 64-QAM and 256-QAM, while lower order modulation schemes may refer to modulation schemes that encode fewer than a threshold numerical quantity of bits per symbol, such as QPSK and 16-QAM. For example, 256-QAM may have a lower average EVM threshold (e.g., corresponding to a greater signal quality) than 64-QAM, which in turn may have a lower average EVM threshold than 16-QAM. In some cases, 256-QAM may have an average EVM threshold of approximately 3.5% or better, while 64-QAM may have an average EVM threshold of approximately 8% or better, and 16-QAM may have an average EVM threshold of approximately 17.5% or better. The lower average EVM threshold for higher order modulation schemes may result from a closer spacing of constellation points (e.g., assuming the constellations are scaled to have equal average power), which makes the higher order modulation schemes more sensitive to noise, interference, and transmitter imperfections.

The EVM is a measure of the difference between a reference waveform and a measured waveform, which is referred to as an error vector. The reference waveform may represent an ideal, theoretical signal that corresponds to an intended transmitted symbols without impairments, while the measured waveform may represent an actual signal as captured at the output of the transmitter or at a measurement point in the signal path, including any distortions, noise, or other imperfections introduced by the transmitter. Before calculating the EVM, a UE 104 and/or an NE 102 may correct a measured waveform by a sample timing offset and radio frequency offset. Then, the UE 104 and/or an NE 102 may remove carrier leakage from the measured waveform before calculating the EVM. The measured waveform is further equalized using one or more channel estimates subjected to a defined (e.g., specified, preconfigured, hardcoded, configured) EVM equalizer spectrum flatness criterion. For Discrete Fourier Transform-spread-OFDM (DFT-s-OFDM) waveforms, the EVM result is defined after the front-end Fast Fourier Transform (FFT) and inverse DFT (IDFT) as the square root of the ratio of the mean error vector power to the mean reference power expressed as a percentage. For cyclic prefix-OFDM (CP-OFDM) waveforms, the EVM result is defined after the front-end FFT as the square root of the ratio of the mean error vector power to the mean reference power expressed as a percentage.

A basic EVM measurement interval in the time domain is one preamble sequence for the physical random access channel (PRACH) and one slot for a physical uplink control channel (PUCCH) and a physical uplink shared channel (PUSCH) in the time domain. The EVM measurement interval is reduced by any symbols that include an allowable power transient in the measurement interval. The root mean square (RMS) average of the basic EVM measurements over ten subframes for the average EVM case, and over sixty subframes for the reference signal EVM case, for the different modulation schemes may not exceed the values in Table 1 for the parameters defined in Table 2. For EVM evaluation purposes, each of the thirteen PRACH preamble formats and each of the five PUCCH formats are considered to have the same EVM criterion as QPSK modulated. Unless otherwise indicated,

$$\frac{π}{2}$$

BPSK in this clause refers to both variants of

$$\frac{π}{2}$$

BPSK referenced in Table 1.

TABLE 1
Average EVM thresholds

| Parameter | Unit | Average EVM Level |
|---|---|---|
| $\frac{π}{2}$ | % | 30 |
| BPSK | | |
| QPSK | % | 17.5 |
| 16-QAM | % | 12.5 |
| 64-QAM | % | 8 |
| 256-QAM | % | 3.5 |

TABLE 2
Parameters for EVM

| Parameter | Unit | Level |
|---|---|---|
| UE output power | decibel-milliwatts | ≥Table 1 |
| | (dBm) | |
| UE output power | dBm | ≥Table 1 + 10 dB |
| for 256-QAM | | |
| Operating conditions | | Normal conditions |

Additionally, or alternatively, ACLR criterion may become more stringent for higher order modulation schemes. For example, 256-QAM may have a more stringent ACLR criterion (e.g., a higher ACLR performance requirement) compared to 64-QAM or 16-QAM to maintain a threshold signal quality and to reduce interference to adjacent channels. The increased sensitivity of higher order modulation schemes to power amplifier non-linearities may contribute to degraded ACLR performance at higher transmit power levels. Additionally, or alternatively, in-band emission criterion may vary based on the modulation type. Higher order modulation schemes, such as 256-QAM, may be more susceptible to in-band emissions, including LO leakage and I/Q image power, which can degrade the signal quality and reduce the effective signal-to-noise ratio (SNR). The I/Q image power may be problematic for higher order modulation schemes because the I/Q image signals can interfere with the desired signal constellation points, leading to increased EVM and reduced demodulation performance.

The in-band emission is defined as the average emission across twelve sub-carriers and as a function of an RB offset from an edge of an allocated uplink transmission bandwidth. The in-band emission is measured as the ratio of the UE output (e.g., transmit) power in a non-allocated RB to the UE output power in an allocated RB. A basic in-band emissions measurement interval is defined over one slot in the time domain. The minimum criterion applies when the in-band emission measurement is averaged over ten sub-frames. If the PUSCH or PUCCH transmission slot is shortened due to multiplexing with a sounding reference signal (SRS), then the in-band emissions measurement interval is reduced by one or more symbols, accordingly. The average of the basic in-band emission measurement over ten sub-frames may not exceed the values specified in Table 3. Unless otherwise specified,

$$\frac{π}{2}$$

BPSK refers to both variants of

$$\frac{π}{2}$$

BPSK referenced in Table 1.

TABLE 3
Criterion for in-band emissions

| Parameter | | | | Applicable |
|---|---|---|---|---|
| description | Unit | Limit (NOTE 1) | | frequencies |
| General | dB | $max \{ - 25 - 10 * {log}_{10} ( \frac{{N}_{RB}}{{L}_{CRB}} ) , {log}_{10} EVM - 3 - 5 * \frac{\vert {Δ}_{RB} \vert - 1}{{L}_{CRB}} , - 57 dBM + 10 {log}_{10} ( \frac{SCS}{15 kHz} ) - \overline{{P}_{RB}} \}$ | | Any non-allocated (NOTE 2) |
| IQ Image | dB | -28 | Image frequencies when output power > 10 dBm | Image frequencies |
| | | -25 | Image frequencies when output power ≤ 10 dBm | (NOTES 2, 3) |
| Carrier | Decibels | -28 | Output power > 10 dBm | Carrier leakage |
| leakage | relative to | -25 | 0 dBm ≤ Output power ≤ 10 dBm | frequency |
| | the carrier | -20 | -30 dBm ≤ Output power < 0 dBm | (NOTES 4, 5) |
| | (dBc) | -10 | -40 dBm ≤ Output power < - 30 dBm | |

NOTE 1
An in-band emissions combined limit is evaluated in each non-allocated RB. For each non-allocated RB, the minimum requirement is calculated as the higher of P̅_̅{̅R̅B̅}̅ - 30 dB and the power sum of each of the limit values (e.g., general, I/Q image, or carrier leakage) that apply. P̅_̅{̅R̅B̅}̅ is defined in NOTE 10.
NOTE 2
The measurement bandwidth is one RB, and the limit is expressed as a ratio of measured power in one non-allocated RB to the measured average power per allocated
$RB , where the averaging is done across each of the allocated RBs . For \frac{π}{2} BPSK with$ spectrum shaping, the limit is expressed as a ratio of measured power in one non-allocated RB to the measured power in the allocated RB with highest power spectral density (PSD).
NOTE 3
The applicable frequencies for this limit are those that are enclosed in the reflection of the allocated bandwidth, based on symmetry with respect to the carrier leakage frequency, but excluding allocated RBs.
NOTE 4
The measurement bandwidth is one RB, and the limit is expressed as a ratio of measured power in one non-allocated RB to the measured total power in each of the allocated RBs.
NOTE 5
The applicable frequencies for this limit depend on the parameter txDirectCurrentLocation in an UplinkTxDirectCurrent information element (IE), and are enclosed either in the RB including the carrier leakage frequency, or in the two RBs immediately adjacent to the carrier leakage frequency but excluding allocated RBs.
NOTE 6
L_{CRB} is the transmission bandwidth
NOTE 7
N_{RB} is the Transmission bandwidth configuration.
NOTE 8
EVM is the limit specified in Table 1 for the modulation type (e.g., scheme, format) used in the allocated RBs.
NOTE 9
Δ_{RB} is the starting frequency offset between the allocated RB and the measured non-allocated RB (e.g., Δ_{RB} = 1 or Δ_{RB} = - 1) for the first adjacent RB outside of the allocated bandwidth.
NOTE 10
P̅_̅{̅R̅B̅}̅ is an average of the transmitted power over ten sub-frames normalized by the number of allocated RBs, measured in dBm.
NOTE 11
For almost contiguous allocations, L_{CRB} = N_{RB}_alloc + N_{RB}_gap with no in-gap emission requirement.

In some cases, a UE 104 may set a maximum transmit power for an uplink transmission. For example, the UE 104 may set a configured maximum output power, P_{CMAX,f,c}, for a carrier, f, of a serving cell, c, in each slot. The UE 104 may set a value of P_{CMAX,f,c} within the bounds P_{CMAX_L,f,c}≤P_{CMAX,f,c}≤P_{CMAX_H,f,c}, with P_{CMAX_L,f,c} calculated according to Equation 1 and P_{CMAX_H,f,c} calculated according to Equation 2.

P_{CMAX_L,f,c}=MIN{P_{EMAX,c}−ΔT_{C,c},(P_{PowerClass}−ΔP_{PowerClass})−MAX(MAX(MPR_{c}+ΔMPR_{c},A-MPR_{c})+ΔT_{IB,c}+ΔT_{C,c}+ΔT_{RxSRS},P-MPR_{c})} (1)

P_{CMAX_H,f,c}=MIN{P_{EMAX,c},P_{PowerClass}−ΔP_{PowerClass}}, (2)

where P_{EMAX,c} is the value given by either a p-Max IE or a field additionalPmax of the NR-NS-PmaxList IE. P_{PowerClass} is a maximum UE power defined for shared spectrum access operation, without considering a tolerance defined for the shared spectrum access operation. If the IE powerBoostPi2BPSK is set to 1, then P_{EMAX,c} is increased by 3 dB for a power class 3 UE operating in time division duplex (TDD) bands n40, n41, n77, n78, and n79 with

$$\frac{π}{2}$$

BPSK modulation with a demodulation reference signal (DMRS), and if a UE 104 indicates support for UE capability powerBoosting-pi2BPSK and 40% or less symbols in certain evaluation period are used for uplink transmission if P_{EMAX,c} is greater than or equal to 20 dBm (e.g., the exact evaluation period is no less than one radio frame). If the IE powerBoostPi2BPSK is set to 1, then ΔP_{PowerClass} is equal to −3 dB for a power class 3 UE operating in TDD bands n40, n41, n77, n78, and n79 with

$$\frac{π}{2}$$

BPSK modulation with a DMRS and if a UE 104 indicates support for UE capability powerBoosting-pi2BPSK and 40% or less slots in radio frame are used for uplink transmission.

In some cases, ΔP_{PowerClass} is equal to 3 dB for a power class 2 UE or 6 dB for a power class 1.5 UE if P-max of 23 dBm or lower is indicated. Additionally, or alternatively, AP PowerClass is equal to 3 dB for a power class 2 UE or 6 dB for a power class 1.5 UE if the field of UE capability maxUplinkDutyCycle-PC2-FR1 is absent and the field of UE capability maxUplinkDutyCycle-PCIdot5-MPE-FR1 is absent and the percentage of uplink symbols transmitted in a defined evaluation period is larger than 50%. Additionally, or alternatively, ΔP_{PowerClass} is equal to 3 dB for a power class 2 UE or 6 dB for a power class 1.5 UE if the field of UE capability maxUplinkDutyCycle-PC2-FR1 is not absent and the percentage of uplink symbols transmitted in a defined evaluation period is larger than maxUplinkDutyCycle-PC2-FR1 (e.g., the exact evaluation period is no less than one radio frame). Additionally, or alternatively, ΔP_{PowerClass} is equal to 3 dB for a power class 2 UE or 6 dB for a power class 1.5 UE if the field of UE capability maxUplinkDutyCycle-PCIdot5-MPE-FR1 is not absent and half the percentage of uplink symbols transmitted in a defined evaluation period is larger than maxUplinkDutyCycle-PCIdot5-MPE-FR1 (e.g., the exact evaluation period is no less than one radio frame).

In some cases, ΔP_{PowerClass} is equal to 3 dB for a power class 1.5 UE if P-max is between 23 dBm and 26 dB. Additionally, or alternatively, ΔP_{PowerClass} is equal to 3 dB if the field of UE capability maxUplinkDutyCycle-PC2-FR1 is absent and the field of UE capability maxUplinkDutyCycle-PC1dot5-MPE-FR1 is absent and the percentage of uplink symbols transmitted in a defined evaluation period is between 25% and 50%. Additionally, or alternatively, ΔP_{PowerClass} is equal to 3 dB if the field of UE capability maxUplinkDutyCycle-PC2-FR1 is not absent and the percentage of uplink symbols transmitted in a certain evaluation period is between maxUplinkDutyCycle-PC2-FR1 and maxUplinkDutyCycle-PC2-FR1/2 (e.g., the exact evaluation period is no less than one radio frame). Additionally, or alternatively, ΔP_{PowerClass} is equal to 3 dB if the field of UE capability maxUplinkDutyCycle-PCIdot5-MPE-FR1 is not absent and the percentage of uplink symbols transmitted in a defined evaluation period is larger than maxUplinkDutyCycle-PCIdot5-MPE-FR1 (e.g., the exact evaluation period is no less than one radio frame).

Additionally, or alternatively, ΔP_{PowerClass} is equal to 3 dB if the UE 104 is configured with supplementary uplink (SUL) configurations and the criterion of a default power class are applied on the band, where UE indicates power class 2. Additionally, or alternatively, a AP PowerClass of 3 dB is applied during SRS transmission occasions with usage in SRS-ResourceSet set as ‘antennaSwitching’ with configured SRS resources in each SRS resource set including one SRS port if a PC2 UE with txDiversity-r16 capability or PC1.5 UE further indicates SRS-TxSwitch capability ‘t1r2’ or ‘t1r4’ or ‘t1r1-t1r2’ or ‘t1r1-t1r2-t1r4’. The ΔP_{PowerClass} is equal to 0 dB otherwise.

In some cases, ΔT_{IB,c} is the additional tolerance for serving cell, c, as defined for NR carrier aggregation (CA), for SUL, or for evolved universal mobile telecommunications system (UMTS) terrestrial radio access (E-UTRA)-NR dual connectivity (DC) (EN-DC). For other cases, ΔT_{IB,c} is equal to 0 dB. If the UE 104 supports more than one band combination for V2X operating bands for concurrent operation, CA, SUL, or DC, and an operating band belongs to more than one band combination, and if the operating band frequency range is less than or equal to one GHz, then the applicable additional ΔT_{IB,c} may be the average value for all defined band combinations, truncated to one decimal place that apply for that operating band among the supported band combinations. If there is a harmonic relation between low band uplink and high band downlink, then the maximum ΔT_{IB,c} among the different supported band combinations involving such band is applied. If the operating band frequency range is greater than one GHz, then the applicable additional ΔT_{IB,c} may be the maximum value for all defined band combinations for the applicable operating bands. In some cases, ΔT_{C,c} is equal to 1.5 dB when one or more conditions for a serving cell, c, are met and is equal to 0 dB otherwise.

A maximum power reduction for a serving cell, c, and an additional maximum power reduction for the serving cell, c, A-MPR_{c} are power reduction values applied to limit transmit power based on modulation schemes and transmission configurations to ensure compliance with spectral emission thresholds and adjacent channel interference limits. In some cases, ΔMPR_{c} for the serving cell, c, is an additional power reduction value applied under one or more transmission conditions to maintain signal quality and regulatory compliance. A delta tolerance for SRS reception, ΔT_{RxSRS} ( ) is applied during SRS transmission occasions when the SRS resource set usage is configured for antenna switching operations, where SRSs are uplink reference signals used for channel quality measurement and antenna selection. In some cases, the UE 104 transmits an SRS on the second SRS resource in every configured SRS resource set when the SRS transmission switching capability supports one transmit antenna and two receive antennas (t1r2) or supports both single antenna and dual antenna configurations (t1r1−t1r2). Additionally, or alternatively, the UE 104 transmits an SRS on the second, third, and fourth SRS resources of the total four SRS resources from all configured SRS resource sets including one SRS port when the SRS transmission switching capability supports various antenna configurations including one transmit with four receive antennas (t1r4), two transmit with four receive antennas (t1r4−t2r4), or multiple antenna switching combinations. Additionally, or alternatively, the UE 104 transmits an SRS from the SRS port pair on the second SRS resource in every configured SRS resource set including two SRS ports when the SRS transmission switching capability supports two transmit antennas with four receive antennas (t2r4) or various multi-antenna configurations. Additionally, or alternatively, the UE 104 transmits an SRS to a downlink carrier, which is a frequency carrier designated for downlink transmissions from the NE 102 to the UE 104.

In some examples, the value of ΔT_{RxSRS} is 4.5 dB for frequency bands with an upper uplink frequency (F_{UL_high}) that is higher than the lower uplink frequency of band n79 and 3 dB for bands with an upper uplink frequency that is lower than the lower uplink frequency of band n79 when the device operates as power class 3, power class 5, power class 1.5, or power class 2 with a 3 dB power class reduction, or when the UE 104 supports transmit diversity capabilities. The value of ΔT_{RxSRS} is 7.5 dB for frequency bands with an upper uplink frequency that is higher than the lower uplink frequency of band n79 and 6 dB for bands with an upper uplink frequency that is lower than the lower uplink frequency of band n79 during SRS transmission occasions with configured SRS resources consisting of one SRS port when the device is power class 2 with no power class reduction (ΔP_{PowerClass}=0 dB) and does not support transmit diversity. For all other SRS transmissions not meeting the above conditions, ΔT_{RxSRS} is zero.

A power management maximum power reduction for a serving cell, c, P-MPR_{c}, is a power reduction applied to ensure compliance with regulatory criterion and address interference issues in one or more operational scenarios. For example, P-MPR_{c} is the power management maximum power reduction for ensuring compliance with applicable EM energy absorption criterion and addressing unwanted emissions or self-desensitization criterion when the UE 104 simultaneously transmits on multiple radio access technologies. Additionally, or alternatively, P-MPR_{c} is the power management maximum power reduction for ensuring compliance with applicable EM energy absorption thresholds when proximity detection systems are used to detect nearby objects or human presence, resulting in reduced maximum output power for safety. In some cases, the UE 104 may apply P-MPR_{c} for the serving cell, c, for the above specified cases. For UE conducted conformance testing, P-MPR_{c} is 0 dB, meaning no power reduction is applied during standardized testing procedures. P-MPR_{c} was introduced in the P_{CMAX,f,c} equation to enable a UE 104 to report the available maximum output transmit power to the NE 102. This information can be used by the NE 102 for scheduling decisions and resource allocation. P-MPR, may impact the maximum uplink performance for the selected uplink transmission path by reducing the available transmit power and potentially affecting data throughput and coverage.

A power amplifier operating point may affect signal quality differently across modulation types. In some cases, lower order modulation schemes, such as QPSK or 16-QAM, may tolerate higher power amplifier compression levels, providing for higher transmit power levels, while maintaining signal quality. In some other cases, the power amplifier to operate in a more linear region for higher order modulation schemes, such as 64-QAM and 256-QAM, potentially resulting in power back-off to meet signal quality thresholds, which may result in reduced coverage or data rates. That is, the UE 104 may implement an MPR for each modulation type, which may represent a reduction in maximum transmit power that a UE 104 applies to maintain compliance with the metrics or evaluation criterion (e.g., EVM, ACLR, SEM, and/or in-band emissions).

A UE 104 may reduce a maximum output power due to higher order modulations and transmit bandwidth configurations. For UE power classes 1 through 3, an allowed MPR is defined in Table 5, Table 4, and Table 7, respectively for channel bandwidths≤100 MHz. For UE power class 1.5, the allowed MPR is defined in accordance with an indicated modified MPR behavior for channel bandwidths≤100 MHz. If a UE in the power class 1.5 for a given band is limited to power class 2, then the MPR criterion in Table 5 apply. Unless otherwise specified,

$$\frac{π}{2}$$

BPSK refers to both variants of

$$\frac{π}{2}$$

BPSK referenced in Table 4. If a relative channel bandwidth ≤4% for time division duplexing (TDD) bands or ≤3% for frequency division duplexing (FDD) bands, then the ΔMPR is set to zero. If the relative channel bandwidth >4% for TDD bands or >3% for FDD bands, then the ΔMPR is defined in Table 6. In some cases, relative channel bandwidth is

$$2 * \frac{B {W}_{C h a n n e l}}{{F}_{{UL}_{l o w}} + {F}_{{UL}_{h i g h}}} .$$

The allowed MPR for SRS, PUCCH formats 0, 1, 3 and 4, and PRACH is specified as for QPSK modulated DFT-s-OFDM of equivalent RB allocation. The allowed MPR for PUCCH format 2 is specified as for QPSK modulated CP-OFDM of equivalent RB allocation.

TABLE 4
MPR for UE power class 3

| | | MPR (dB) | | |
|---|---|---|---|---|
| | | Edge RB | Outer RB | Inner RB |
| Modulation | | allocations | allocations | allocations |
| DFT-s- OFDM | $\frac{π}{2} - BPSK with DMRS$ | ≤ 3.5¹ ≤ 0.5² | ≤1.2¹ ≤ 0.5² | ≤0.2¹ 0² |
| | $\frac{π}{2} - BPSK with \\ \frac{π}{2} - BPSK \\ DMRS$ | ≤ 0.5² | 0² | 0² |

| | | |
|---|---|---|
| QPSK | ≤ 1 | 0 |
| 16-QAM | ≤ 2 | ≤ 1 |

| | 64-QAM | ≤ 2.5 | |
|---|---|---|---|
| | 256-QAM | ≤ 4.5 | |
| CP- | QPSK | ≤ 3 | ≤ 1.5 |
| OFDM | 16-QAM | ≤ 3 | ≤ 2 |

| | |
|---|---|
| 64-QAM | ≤ 3.5 |
| 256-QAM | ≤ 6.5 |

NOTE 1
$Applicable for UE operating in TDD mode with \frac{π}{2} BPSK modulation and UE indicates$ support for UE capability powerBoosting-pi2BPSK and if the IE powerBoostPi2BPSK is set to 1 and 40% or less slots in radio frame are used for UL transmission for bands n40, n41, n77, n78 and n79. The reference power of 0 dB MPR is 26 dBm.
NOTE 2
Applicable for conditions where NOTE 1 does not apply.

TABLE 5
MPR for UE power class 2

| | | MPR (dB) | | |
|---|---|---|---|---|
| | | Edge RB | Outer RB | Inner RB |
| Modulation | | allocations | allocations | allocations |
| DFT-s-OFDM | $\frac{π}{2} BPSK$ | ≤ 3.5 | ≤ 0.5 | 0 |
| | QPSK | ≤ 3.5 | ≤ 1 | 0 |
| | 16-QAM | ≤ 3.5 | ≤ 2 | ≤ 1 |
| | 64-QAM | ≤ 3.5 | ≤ 2.5 | |
| | 256-QAM | ≤ 4.5 | | |
| CP-OFDM | QPSK | ≤ 3.5 | ≤ 3 | ≤ 1.5 |
| | 16-QAM | ≤ 3.5 | ≤ 3 | ≤ 2 |

| | |
|---|---|
| 64-QAM | ≤ 3.5 |
| 256-QAM | ≤ 6.5 |

TABLE 6
ΔMPR

| NR Band | Power class | Channel bandwidth | ΔMPR (dB) |
|---|---|---|---|
| n28 and n83 | Power class 3 | 25 MHz, 30 MHZ | 0.5 |
| n40 and n97 | Power class 3 and | 100 MHZ | 1 |
| | power class 2 | | |

TABLE 7
MPR for UE power class 1

| | | MPR (dB) | | |
|---|---|---|---|---|
| | | Edge RB | Outer RB | Inner RB |
| Modulation | | allocations | allocations | allocations |
| DFT-s- OFDM | $\frac{π}{2} - BPSK with DMRS$ | ≤ 0.5 | ≤ 0.5 | 0 |
| | $\frac{π}{2} - BPSK with \\ \frac{π}{2} - BPSK \\ DMRS$ | ≤ 0.5 | 0 | 0 |

| | QPSK | ≤ 1 | 0 |
|---|---|---|---|
| | 16-QAM | ≤ 2 | ≤ 1 |
| | 64-QAM | ≤ 2.5 | |
| | 256-QAM | ≤ 4.5 | |
| CP- | QPSK | ≤ 3 | ≤ 1.5 |
| OFDM | 16-QAM | ≤ 3 | ≤ 2 |

| | |
|---|---|
| 64-QAM | ≤ 3.5 |
| 256-QAM | ≤ 6.5 |

The following parameters are defined to indicate RB allocation ranges for outer and inner RB allocations. NRB is a maximum number of RBs for a defined channel bandwidth and sub-carrier spacing. For example, RB_{Start,Low}=max(1, floor(L_{CRB}/2)), where max( ) indicates a largest value of all arguments and floor(x) is a greatest integer less than or equal to x. In some cases, RB_{Start,High}=N_{RB}−RB_{Start,Low}−L_{CRB}. The RB allocation is an inner RB allocation if RB_{Start,Low}≤RB_{Start}≤RB_{Start,High} and L_{CRB}≤ceil(N_{RB}/2), where ceil(x) is a smallest integer greater than or equal to x. An Edge RB allocation is the one for which one or more RBs are allocated at the lowermost or uppermost edge of the channel (e.g., L_{CRB}≤2 RBs). The RB allocation is an outer RB allocation for all other allocations which are not an inner RB allocation or edge RB allocation.

If CP-OFDM allocation satisfies N_{RB_gap}/(N_{RB_alloc}+N_{RB_gap)}≤0.25, then the CP-OFDM allocation is considered as almost contiguous allocation. In some cases, N_{RB_alloc}+N_{RB_gap} is greater than 106, 51 or 24 RBs for 15 kHz, 30 kHz, or 60 kHz, respectively, where N_{RB_gap i}s the total number of unallocated RBs between allocated RBs and N_{RB_alloc} is the total number of allocated RBs. The size and location of allocated and unallocated RBs are indicated by RB group (RBG) parameters. For a UE 104 that indicates support for almostContiguousCP-OFDM-UL, the almost contiguous signals in power classes 1.5, 2, and 3, the allowed MPR defined in Table 5, Table 4, and defined for power class 1.5 are increased by CEIL {10 log₁₀(1+N_{RB_gap}/N_{RB_alloc}), 0.5} dB, where CEIL {x, 0.5} means x rounding upwards to a closest 0.5 dB. The parameter of L_{CRB}, which is used to specify valid RB allocation ranges for outer and inner RB allocations, is replaced by (N_{RB_alloc}+N_{RB_gap}) for almost contiguous allocation cases. For the UE maximum output power modified by MPR, one or more power limits may apply.

One of the objectives in the wireless communications system 100 is to increase the transmit power available for higher order modulation schemes, such as 64-QAM and 256-QAM, so that the modulation schemes can be used over a larger portion of the cell. However, the higher order modulation schemes are sensitive to power amplifier non-linearities and implement more stringent signal quality criterion. For example, higher transmit power levels may introduce non-linearities in the transmit chain, increasing EVM and degrading other signal quality metrics. According to implementations, one or more of the NEs 102 and the UEs 104 are operable to implement various aspects of the techniques described with reference to the present disclosure. For example, a UE 104 receives scheduling information from an NE 102 that indicates one or more time-frequency resources to use for transmitting data or control information (e.g., an uplink transmission) to the NE 102. The time-frequency resources can include an RB allocation for the uplink transmission. In some cases, the UE 104 may implement one or more updated MPRs based on an overlap between the allocated RBs and an I/Q image (e.g., unwanted signal copies of a signal generated by the transmitter of the UE 104), where the overlap causes interfere with the intended transmission. For example, if the I/Q images overlap with the allocated RBs, then the UE 104 may have a greater MPR, such that the UE can reduce a maximum transmit power to maintain a threshold signal quality and to meet regulatory emission limits. In some other examples, if the I/Q images do not overlap or partially overlap with the allocated RBs, then the UE 104 may have a lower MPR, such that the UE may transmit with a higher transmit power and still maintain the threshold signal quality and meet the regulatory emission limits. The NE 102 can control (e.g., manage, coordinate) the MPR by providing the resource allocation information that causes the least amount of overlap between the allocated resources and the I/Q image, resulting in higher transmit power for higher order modulation schemes. The UE 104 may transmit the uplink transmission to the NE 102 utilizing a transmit power that is less than the selected maximum transmit power, which accounts for the MPR.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

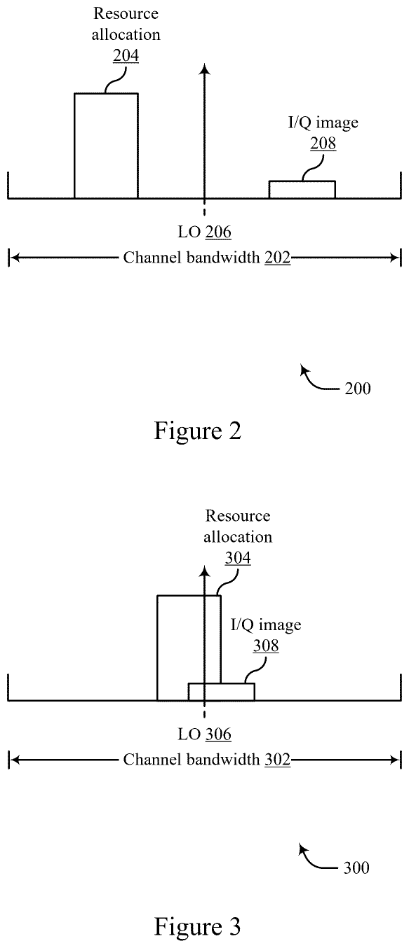

FIG. 2 illustrates an example of a resource diagram 200 in accordance with aspects of the present disclosure. In some examples, the resource diagram 200 implements or is implemented by aspects of the wireless communications system 100. For example, the resource diagram 200 may be implemented by a UE and/or an NE, which may be an example of an NE 102 and a UE 104 as described with reference to FIG. 1. Although reference is made herein to uplink transmissions from a UE to an NE, the described techniques may also be applicable to downlink transmissions from an NE to a UE and/or to sidelink transmissions from a UE to another UE.

In some cases, an NE may transmit signaling (e.g., control signaling, including RRC signaling, a MAC-CE, or a DCI, among other examples of control signaling) that includes a time-frequency resource allocation in a channel bandwidth 202 to one or more UEs. For example, the NE may transmit signaling that includes the resource allocation 204 to a UE. The resource allocation 204 may indicate resources in the time domain and the frequency domain that the UE is to use for transmitting and/or receiving signaling. For example, the resource allocation 204 may indicate one or more RBs, also referred to as an RB allocation, for the UE to use for transmitting and/or receiving. The RBs may span a portion of the channel bandwidth 202. The channel bandwidth 202 may represent a total frequency spectrum available for uplink and/or downlink transmissions within a frequency band or carrier. The channel bandwidth 202 may be divided into multiple frequency resources, such as RBs, subcarriers, or other frequency units, that the NE allocates to one or more UEs (e.g., in the resource allocation 204) for data transmission and reception.

In some cases, the channel bandwidth 202 may include an LO frequency 206. The LO frequency 206 may represent a reference frequency generated by an LO circuit within a transmitter or receiver chain. The LO may provide a frequency reference that is used for frequency conversion operations, such as up-converting baseband signals to radio frequency for transmission or down-converting received radio frequency signals to baseband for processing. The LO frequency 206 may be positioned within or near the channel bandwidth 202 and may serve as a center frequency around which frequency translation operations occur. In some cases, the LO frequency 206 may be adjustable or configurable to support different carrier frequencies or to improve signal processing performance for various transmission scenarios.

The UE may select a transmit power for the uplink transmission. For example, the UE may set a maximum transmit power according to various power control parameters, including the parameters in Equations 1 and 2, as well as various regulatory limits or emission criterion, as described with reference to FIG. 1. The maximum transmit power may be subject to various reductions, including an MPR that accounts for modulation, signal quality criterion, and other emission criterion. The MPR may vary according to the modulation type (e.g., QPSK, 16-QAM, 64-QAM, 256-QAM), RB allocation type (e.g., inner, outer, edge), and waveform type (e.g., DFT-s-OFDM, CP-OFDM). The UE may determine a final transmit power for the uplink transmission that is less than or equal to the maximum transmit power, accounting for the applicable MPR and other power control adjustments to ensure compliance with emission criterion, while maintaining a threshold signal quality for successful data transmission. In some examples, such as for higher order modulation types, including 64-QAM and 256-QAM, the UE may benefit from increasing the transmit power so that the modulation types can be used over a larger portion of a cell. Since 64-QAM and 256-QAM correspond to 6 bits per symbol and 8 bits per symbol, respectively, higher user and system throughput can be achieved if the modulation types are used over a larger portion of the cell. However, the UE may be unable to increase a transmit power past a threshold set to satisfy one or more emission criterion at the UE. For example, the EVM thresholds, as shown in Table 1, limit the power available for 64-QAM and 256-QAM.

Since the transmit power for higher order modulation types (e.g., 64-QAM and 256-QAM) is limited by EVM thresholds for transmission, relaxation of the EVM thresholds for higher order modulation types and implementation of an advanced NE receiver can enhance UE output power and improve uplink coverage. For the UE, each modulation type has an associated MPR that the UE may implement or use to meet emission criterion. The emission criterion include, but are not limited to, ACLR criterion, SEM criterion, spurious emission criterion, in-band emission criterion (e.g., including limits on power transmitted in unallocated RBs with the limit depending on distance between unallocated RB and nearest allocated RB, LO leakage, and I/Q image power limits on RBs symmetrically located relative to the LO frequency 206), and EVM criterion or thresholds.

The ACLR criterion, SEM criterion, and spurious emission criterion are coexistence criterion to protect users in other channels and bands. The in-band emission criterion is primarily a coexistence criterion that protects the RBs allocated to other UEs by reducing the interference from the transmitting UE to other UEs. The I/Q image criterion of the in-band emission criterion may also be a transmitter quality criterion. The resource diagram 200 includes the resource allocation 204 and a corresponding I/Q image 208 due to gain and phase imbalances in a modulator. The I/Q image 208 may represent an unwanted signal copy that appears at a frequency symmetrically opposite to the desired signal frequency relative to the LO frequency 206, resulting from imperfections in the in-phase and quadrature signal paths of the transmitter. The I/Q image criterion may specify limits on the power of the I/Q image signals (e.g., the I/Q image 208) to prevent or reduce interference with the resource allocation 204 and to maintain signal quality, including for higher order modulation schemes with constellation points that are more closely spaced and sensitive to the I/Q image 208.

In some examples, the resource allocation 204 does not overlap with the LO frequency 206, so the resource allocation 204 and the I/Q image 208 do not overlap. If the resource allocation 204 and the I/Q image 208 do not overlap, then the I/Q image 208 may have minimal impact on the signal quality of the uplink transmission within the resource allocation 204 (e.g., less than a threshold change to the signal quality). The UE may apply a lower MPR compared to scenarios where the I/Q image 208 overlaps with the resource allocation 204 (e.g., as described with reference to FIG. 3), as the I/Q image power may not directly interfere with the allocated RBs. The UE may transmit at a higher power level if the resource allocation 204 and the I/Q image 208 do not overlap, while still meeting the in-band emission criterion and maintaining acceptable signal quality metrics, such as EVM thresholds.

FIG. 3 illustrates an example of a resource diagram 300 in accordance with aspects of the present disclosure. In some examples, the resource diagram 300 implements or is implemented by aspects of the wireless communications system 100 and the resource diagram 200. For example, the resource diagram 300 may be implemented by a UE and/or an NE, which may be an example of an NE 102 and a UE 104 as described with reference to FIG. 1. The resource diagram 300 may include a channel bandwidth 302, a resource allocation 304, an LO frequency 306, and an I/Q image 308, which may be examples of a channel bandwidth 202, a resource allocation 204, an LO frequency 206, and an I/Q image 208, respectively, as described with reference to FIG. 2. Although reference is made herein to uplink transmissions from a UE to an NE, the described techniques may also be applicable to downlink transmissions from an NE to a UE and/or to sidelink transmissions from a UE to another UE.

In some examples, the resource allocation 304 overlaps with the LO frequency 306, so the resource allocation 304 and the I/Q image 308 overlap. If the resource allocation 304 and the I/Q image 308 overlap, then the I/Q image 308 may negatively impact the signal quality of the uplink transmission within the resource allocation 304 (e.g., greater than a threshold change to the signal quality). The UE may apply a higher MPR compared to scenarios where the I/Q image 308 does not overlap with the resource allocation 304 (e.g., as described with reference to FIG. 2), as the I/Q image power may directly interfere with the allocated RBs. The UE may transmit at a lower power level if the resource allocation 304 and the I/Q image 308 overlap to meet the in-band emission criterion and maintain acceptable signal quality metrics, such as EVM thresholds.

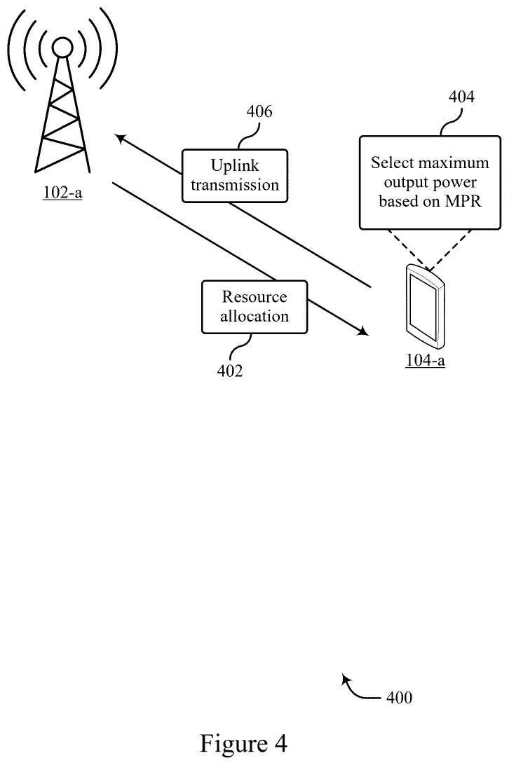

FIG. 4 illustrates an example of a wireless communications system 400 in accordance with aspects of the present disclosure. In some examples, the wireless communications system 400 implements or is implemented by aspects of the wireless communications system 100, the resource diagram 200, and the resource diagram 300. For example, the wireless communications system 400 may include an NE 102-a and a UE 104-a, which may be an example of an NE 102 and a UE 104 as described with reference to FIG. 1. Although reference is made herein to uplink transmissions from the UE 104-a to the NE 102-a, the described techniques may also be applicable to downlink transmissions from the NE 102-a to the UE 104-a and/or to sidelink transmissions from the UE 104-a to another UE.

In some cases, the UE 104-a may receive a resource allocation 402 from the NE 102-a. The resource allocation may be an example of the resource allocation 204 and/or the resource allocation 304, as described with reference to FIGS. 2 and 3. For example, the resource allocation 402 may indicate one or more resources in both the time domain and the frequency domain. The resource allocation 402 may include an RB allocation that indicates one or more RBs for the UE 104-a to use for an uplink transmission to the NE 102-a. The UE 104-a may select a transmit power for the uplink transmission that satisfies one or more emission criterion. The emission criterion may include, but is not limited to, ACLR criterion, SEM criterion, spurious emission criterion, in-band emission criterion (e.g., including limits on power transmitted in unallocated RBs with the limit depending on distance between unallocated RB and nearest allocated RB, LO leakage, and I/Q image power limits on RBs symmetrically located relative to the LO frequency), and EVM criterion or thresholds.

The EVM is a measure of the quality of the transmitted signal, such as a measure of the SNR of the transmitted signal. There may be a different EVM threshold for each modulation type, as shown in Table 1. EVM can be converted to SNR in dB according to Equation 3:

$$SNR = 10 {{log}_{10} ( \frac{1}{\frac{E V M}{100}} )}^{2} . \qquad ( 3 )$$

For example, an EVM of 3.5% corresponds to an SNR of 29.1 dB. An SNR at another end of a channel from the transmitter cannot be better than the EVM at the transmitter due to the channel between the transmitter and receiver having both time and frequency selective fading (e.g., from multipath). The receiver may also add impairments and thermal noise to the received signal. However, if a same receiver is used to measure EVM at both the transmitter and the receiver, then the measured EVM is dependent on the receiver used to define the EVM. For a single antenna transmission, the receiver used to define the EVM depends on a modulation type (e.g., CP-OFDM or DFT-s-OFDM). After determining a sample timing and estimation and removal of LO leakage, an FFT is used to convert the received signal to the frequency domain. The output of the FFT is then followed by equalization in the frequency domain. For CP-OFDM, the EVM is measured after the equalization, and the EVM is defined (e.g., as a percentage) as 100 times the square-root of the mean-squared error between the transmitted symbol and the demodulated symbol over a set of REs. For DFT-s-OFDM, an inverse DFT is performed before the EVM is measured, and the EVM is defined as 100 times the square-root of the mean-squared error between the transmitted symbol and the demodulated symbol over a set of REs.

In some cases, more advanced receivers can be considered for defining EVM. For multi-antenna transmission, EVM can be defined per antenna, per antenna port, or per layer. For full-rank transmission, zero-forcing or unbiased linear minimum mean-square error (MMSE) receivers can be defined. For transmissions with a number of layers that is less than a number of transmit antennas, linear pseudo-inverse receivers can be used to define EVM. Additionally, or alternatively, MMSE receivers can be used to define EVM if the number of layers is less than the number of transmit antennas. For each of the different types of receivers, non-linear receivers can be considered for use in defining EVM. Non-linear receivers include, but are not limited to, the zero-forcing decision feedback receiver and the MMSE decision feedback receiver. In some examples, impairments, such the LO leakage and the I/Q image, can be directly estimated and subtracted from the received signal before the EVM is measured.

At 404, the UE 104-a may select a maximum output (e.g., transmit) power based on an MPR. The MPR may be an MPR that provides for the UE 104-a to meet the emission criterion when sending (e.g., transmitting, outputting) an uplink transmission 406 utilizing the resources in the resource allocation 402. The UE 104-a may apply an MPR based on one or more tables, such as Table 4 and Table 5, for power class 3 (e.g., PC3) and power class 2 (e.g., PC2), respectively, for a single antenna transmission. From Table 4 and Table 5, the MPR for 64-QAM and 256-QAM is much larger than the MPR for QPSK and 16-QAM. For example, in Table 4 for PC3, the MPR for 256-QAM is 6.5 dB, while the MPR for an inner 16-QAM RB allocation is 2 dB. As a consequence of the much larger MPR, the UE may transmit the uplink transmission 406 with much less power for 256-QAM than for 16-QAM. Thus, 256-QAM may be usable over a much smaller portion of a cell than 16-QAM because the transmitted power will not be sufficient to achieve a threshold SNR at a receiver (e.g., a receiver of other NE 102-a, which may be a base station and/or gNB).

The EVM thresholds for 64-QAM and 256-QAM are 8% and 3.5%, respectively. The EVM thresholds for other modulations are more relaxed. In some cases, the EVM can be reduced by reducing transmit power, such that the power amplifier is operating in a more linear region with less compression. However, the I/Q image impairment is specified in dB and scales linearly with the desired signal. Thus, if the desired signal power is reduced by 5 dB, then the I/Q image is reduced by 5 dB (e.g., and not more). That is, there is no reduction of the I/Q image impairment relative to the signal if the transmit power is reduced, and there is no improvement in the SNR. Instead, if the transmit power is reduced, the I/Q image impairment relative to the signal is worsened, as shown in Table 3, where the I/Q image requirements is −28 dB for power levels above 10 dBm and is −25 dB for power levels less than 10 dBm.

If an RB allocation has the property that two REs are symmetric with respect to the LO, then each of the REs interferes with one another, as described with reference to FIG. 3. If the LO image is specified as −28 dB, then the SNR of each RE is limited to 28 dB due to interference from the symmetrically located RE. As noted in Equation 3, the EVM threshold can be converted to an SNR threshold. If the SNR is limited to 28 dB, then the EVM is limited to

$$EVM \geq \frac{100}{\sqrt{{10}^{( SNR / 10 )}}} = \frac{100}{\sqrt{{10}^{2.8}}} = 4 \% .$$

As a result, the I/Q image impairment puts a lower bound on the EVM of approximately 4%, which is slightly larger than the 3.5% EVM threshold for 256-QAM.

There are contributors to the EVM in addition to, or as an alternative to, the I/Q image impairment at the UE transmitter. Other contributors include, but are not limited to, the power amplifier non-linearity and phase noise. However, because the I/Q image impairment is such a large contributor to the EVM (e.g., greater than a threshold percentage of the EVM), there is little to no margin for the other impairments when the EVM threshold is relatively strict (e.g., small), as is the case for 64-QAM and 256-QAM. The output power of the power amplifier is reduced by a relatively large value (e.g., greater than a threshold output power reduction) to operate in a linear region for 64-QAM and 256-QAM to meet the EVM threshold.

In some examples, an RB allocation does not overlap with an I/Q image, as described with reference to FIG. 2. Since the RB allocations are not degraded by the I/Q image, the other impairments which contribute to EVM (e.g., the power amplifier non-linearity and phase noise) can increase. As a result, the MPR that the UE 104-a uses to reduce the output power of the power amplifier and to improve the power amplifier linearity can be reduced. For Table 4 and Table 5, there are three MPR regions defined, including an inner region, an outer region, and an edge region. The N_{RB} is a maximum number of RBs for a channel bandwidth and subcarrier spacing. In some cases, RB_{Start,Low}=max(1, floor(L_{CRB}/2)), where max( ) indicates the largest value of all arguments and floor(x) is the greatest integer less than or equal to x. The RB_{Start,High}=N_{RB}−RB_{Start,Low}−L_{CRB}. The RB allocation is an inner RB allocation if RB_{Start,Low}≤RB_{Start}≤RB_{Start,High} and L_{CRB}≤ceil(N_{RB}/2), where ceil(x) is a smallest integer greater than or equal to x. The RB allocation is an edge RB allocation if one or more RBs are allocated at the lowermost or uppermost edge of the channel (e.g., L_{CRB}≤2 RBs). The RB allocation is an outer RB allocation for all other allocations that are not an inner RB allocation or an edge RB allocation.

In Table 4 and Table 5, for 64-QAM and 256-QAM, the MPR for all three regions (e.g., the inner region, the outer region, and the edge region) is the same. For 64-QAM and 256-QAM and other higher order modulations, the MPR utilized to meet an EVM threshold is sufficient to provide for the UE 104-a to meet the other emission criterion, including the ACLR and SEM criterion. In some cases, the UE 104-a may implement a new region in the MPR tables for which reduced MPR applies, where the new region may be referred to as a no image interference region. The no image interference region is defined for higher order modulation types (e.g., 64-QAM and 256-QAM) and applies to resource allocations that do not overlap with the location of the LO frequency for the UE 104-a, as described with reference to FIG. 2. Thus, any resource allocation that begins and ends on a same side of the LO frequency is subject to reduced MPR for higher order modulation types. If the LO frequency is located in a center of a carrier, a resource allocation 402 may be in a no image interference region if RB_{Start,Low}+L_{CRB}<floor(N_{RB}/2) or RB_{Start,Low}>ceil(N_{RB}/2). If the LO frequency is located in an RB allocated for the uplink transmission 406, denoted as the RB_{LO}, then the no image interference region can be defined as RB_{Start,Low}+L_{CRB}<RB_{LO} or RB_{Start,Low}>RB_{LO}.

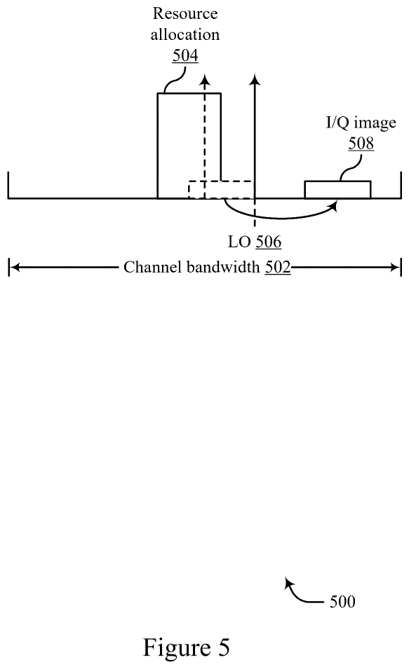

If the LO frequency is located in an RE at an edge of an RB_{LO}, for example in the first or the last RE in the RB, then the no image interference region can be extended with image overlap occurring in one RE. If the LO frequency is located in a first RE of an RB_{LO}, then the no image interference region can defined as RB_{Start,Low}+L_{CRB}<RB_{LO} or RB_{Start,Low}>RB_{LO}. If the LO frequency is located in the last RE of an RB_{LO}, then the no interference region can be defined as RB_{Start,Low}+L_{CRB}≤RB_{LO} or RB_{Start,Low}>RB_{LO}. By moving the LO away from a center of a carrier or to an edge of the carrier, a set of RBs in a resource allocation 402 that overlap with an I/Q image of the resource allocation 402 can be reduced or eliminated, which is described in further detail with respect to FIG. 5.

For higher order modulation types with a resource allocation 402 in a no image interference region, the UE 104-a may reduce the MPR (e.g., the MPR indicated in Table 4 and Table 5 for 64-QAM and 256-QAM). In addition to identifying the no image interference region, the UE 104-a may identify an overlap of the inner region with the other defined regions. For example, the UE 104-a may identify the overlap of the no image interference region and the inner region, the overlap of the no image interference region and the outer region, and/or the overlap of the no image interference region and the edge region. For higher order modulation types with a resource allocation 402 that is not in the no image interference region, the UE 104-a may utilize an MPR that is unchanged (e.g., the MPR from Table 4 and Table 5 for 64-QAM and 256-QAM). That is, the structure of an MPR table may be modified for higher order modulation types according to whether a resource allocation 402 is within a no image interference region, partially within the no image interference region, or outside of the no image interference region. For a resource allocation 402 with no overlap with the I/Q image (e.g., within the no image interference region), the MPR that the UE 104-a utilizes to meet the emission criterion may be reduced (e.g., to a value as low as the MPR for 16-QAM). Table 8 includes example MPR values for higher order modulation types, including 64-QAM and 256-QAM, for both when the I/Q image overlaps with the resource allocation 402 and when there is no overlap (e.g., or less than a threshold overlap) between the I/Q image and the resource allocation 402. In some cases, the MPR values may be different from (e.g., greater than) the values in Table 8 and may be determined by simulation and/or measurements.

TABLE 8
MPR table for reduced MPR for higher order modulation types

| | | MPR (dB) | | | | | |
|---|---|---|---|---|---|---|---|
| | | I/Q image overlaps resource | | | No overlap between I/Q image | | |
| | | allocation | | | and resource allocation | | |
| Modulation | | Edge | Outer | Inner | Edge | Outer | Inner |
| DFT-s- | 64-QAM | ≤2.5 | ≤2.5 | ≤2.5 | ~2 | ~2 | ~1 |
| OFDM | 256- | ≤4.5 | ≤4.5 | ≤4.5 | ~2 | ~2 | ~1 |
| | QAM | | | | | | |
| CP- | 64-QAM | ≤3.5 | ≤3.5 | ≤3.5 | ~3 | ~3 | ~2 |
| OFDM | 256- | ≤6.5 | ≤6.5 | ≤6.5 | ~3 | ~3 | ~2 |
| | QAM | | | | | | |

In some cases, the NE 102-a may signal one or more lookup tables including the MPR values for different modulation types (e.g., including Table 8) to the UE 104-a via control signaling, such as RRC signaling, MAC-CEs, or DCI. For example, the NE 102-a may transmit RRC signaling that includes one or more lookup tables with MPR values corresponding to different modulation types, time-frequency resource allocation (e.g., RB allocation) regions, and I/Q image overlap conditions. Additionally, or alternatively, the UE 104-a may be preconfigured with the MPR information, where the lookup tables are hardcoded or stored in memory during manufacturing or initial configuration. In some cases, the UE 104-a may receive periodic updates to the MPR tables through control signaling to account for changes in network conditions or regulatory criterion. The UE 104-a may determine which lookup table or set of MPR values to apply based on additional parameters signaled by the NE 102-a, such as the LO frequency location, carrier configuration, or emission criterion that apply to a current transmission scenario.

The UE 104-a may transmit the uplink transmission 406 to the NE 102-a by selecting a transmit power that is less than (e.g., satisfies, meets) a maximum transmit power from 404. The maximum transmit power may be reduced by an MPR (e.g., in one or more lookup tables, including in Table 8) according to the overlap between the I/Q image and the resource allocation 402. The UE 104-a may apply the selected transmit power to the uplink transmission 406 to maintain compliance with EVM thresholds and other emission criterion, while enabling higher transmit power levels for improved coverage and data rates with higher order modulation schemes.

FIG. 5 illustrates an example of a resource diagram 500 in accordance with aspects of the present disclosure. In some examples, the resource diagram 500 implements or is implemented by aspects of the wireless communications system 100, the resource diagram 200, the resource diagram 300, and the wireless communications system 400. For example, the resource diagram 500 may be implemented by a UE and/or an NE, which may be an example of an NE 102 and a UE 104 as described with reference to FIGS. 1 and 4. The resource diagram 500 may include a channel bandwidth 502, a resource allocation 504, an LO frequency 506, and an I/Q image 508, which may be examples of the corresponding features as described with reference to FIGS. 1 through 4. Although reference is made herein to uplink transmissions from a UE to an NE, the described techniques may also be applicable to downlink transmissions from an NE to a UE and/or to sidelink transmissions from a UE to another UE.

In some cases, a UE may utilize an LO frequency 506 that is moved (e.g., changed, adjusted) to no longer overlap with the resource allocation 504. As a result, the I/Q image 508 of the resource allocation 504 also moves, such that the I/Q image 508 no longer overlaps with the resource allocation 504. For the transmitter to avoid interference from the I/Q image 508 of the resource allocation 504, the UE can move a location of an LO frequency 506 prior to transmission, such that the LO frequency 506 and the resource allocation 504 do not overlap. If the UE has the capability to move the location of the LO frequency 506, then the UE may transmit signaling to an NE (e.g., a base station, a gNB) that indicates the capability. The UE moving the location of the LO frequency 506 may impact an MPR for an uplink transmission utilizing the resource allocation 504 (e.g., as described with reference to FIG. 4). Thus, moving the location of the LO frequency 506 may also impact the scheduling behavior of the NE (e.g., the time-frequency resources indicated in the resource allocation 504). In some examples, the UE may utilize additional time to move the location of the LO frequency 506 before transmitting the uplink transmission. The UE may transmit signaling to the NE (e.g., same signaling as indicates the capability or different signaling) that indicates a time that the UE takes to move the LO frequency 506. Additionally, or alternatively, the NE may allow or indicate a delay between the resource allocation 504 and the uplink transmission using the resource allocation 504 to provide for the UE to move the LO frequency 506.

In some cases, the UE may move the LO frequency 506 prior to each RB transmission. In some other cases, the UE may periodically move the LO frequency 506 and/or may move the LO frequency 506 according to a trigger or event detection. In some examples, the UE may move the LO frequency 506 for higher order modulation types, including 64-QAM and 256-QAM. If the NE requests information that indicates a location of the LO frequency 506, then the UE may signal the information to the NE. Additionally, or alternatively, the NE may signal the location of the LO frequency 506 to be used to the UE. In some cases, the NE and/or the UE may utilize a configured or defined table or algorithm to determine a location of the LO frequency 506 based on the resource allocation 504. The NE may transmit signaling that indicates parameters regarding the table or algorithm, and may also indicate when the table or algorithm are to be used and if the table or algorithm are to be used for defined modulation types.

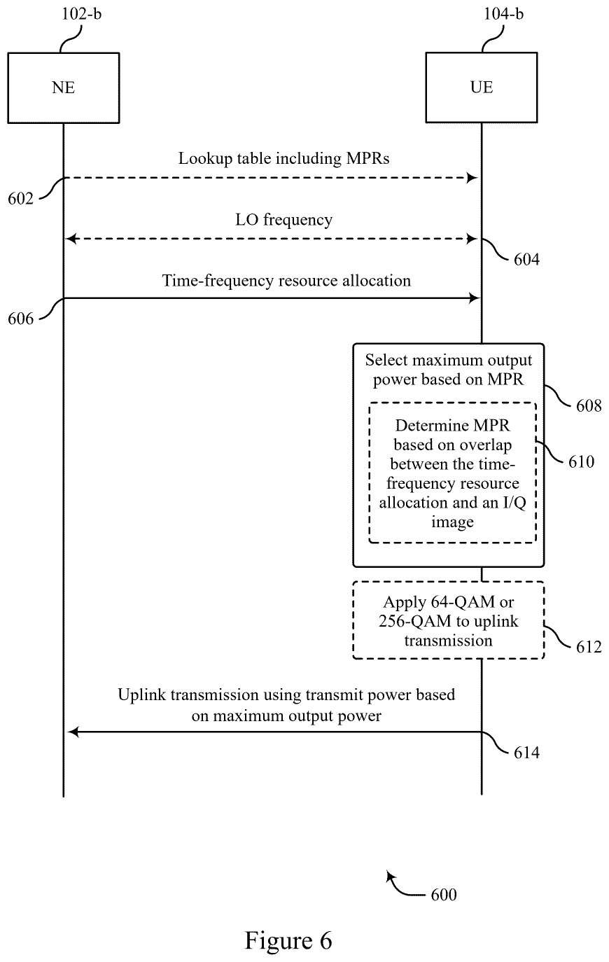

FIG. 6 illustrates an example of a signaling diagram 600 in accordance with aspects of the present disclosure. In some examples, the signaling diagram 600 implements or is implemented by aspects of the wireless communications system 100, the resource diagram 200, the resource diagram 300, the wireless communications system 400, and the resource diagram 500. The signaling diagram 600 may implement or be implemented by one or more devices, such as an NE 102-b and a UE 104-b, which may be examples of an NE 102 and a UE 104 as described with reference to FIGS. 1 and 4. The signaling diagram 600 may illustrate an example of MPR-based transmit power selection for higher order modulation types or schemes that accounts for I/Q image interference in wireless communications. Alternative examples of the following may be implemented, where some processes are performed in a different order than described or are not performed. In some cases, processes may include additional features not mentioned below, or further processes may be added.

In some cases, at 602, the NE 102-b transmits signaling that indicates at least one lookup table including a set of MPRs. The lookup table may indicate different MPR values for higher order modulation schemes, such as 64-QAM or 256-QAM, based on whether an I/Q image overlaps with a resource allocation. The signaling may be transmitted via RRC signaling, MAC-CEs, or DCI. The lookup table may define regions, such as inner, outer, and edge allocations, with further refinement into no image interference regions (e.g., where reduced MPR applies for higher order modulation schemes, including 64-QAM and 256-QAM).

In some examples, at 604, the NE 102-b and/or the UE 104-b transmits signaling that indicates a frequency corresponding to an LO at the UE 104-b and/or an update to the frequency corresponding to the LO. The UE 104-b may signal the LO frequency information to enable the NE 102-b to make scheduling decisions based on an expected MPR. The NE 102-b may utilize the frequency corresponding to the LO (e.g., an LO frequency) to select a time-frequency resource allocation that reduces an overlap between the time-frequency resource allocation and the I/Q image. The NE 102-b may select an MCS corresponding to the time-frequency resource allocation based on the MPR. The NE 102-b utilizes the LO frequency to determine how much MPR the UE can take for a given resource allocation. If the UE 104-a takes above a threshold MPR for a resource allocation, then the NE 102-b may schedule the UE 104-a differently for that lower power level in terms of constellation or modulation. The signaling including the LO location may be an example of RRC signaling (e.g., for semi-static configurations) or may be an example of DCI if the LO is adjusted more dynamically (e.g., per resource allocation).

The update may be provided to reduce the overlap between the time-frequency resource allocation and the I/Q image. The UE 104-b may adjust the frequency corresponding to the LO based on the update to reduce the overlap. For example, by moving the LO frequency away from the center of the carrier or to an edge of the carrier, the set of RBs in the resource allocation that overlap with the I/Q image can be reduced or eliminated.

At 606, the NE 102-b transmits signaling that indicates a time-frequency resource allocation associated with an uplink transmission to the UE 104-b. The time-frequency resource allocation may indicate one or more RBs that the UE 104-b may use for the uplink transmission. The resource allocation may include inner RBs, outer RBs, and/or edge RBs within a channel bandwidth. The NE 102-b may transmit the signaling via DCI in a PDCCH or utilizing higher layer signaling, such as RRC signaling. In some cases, the resource allocation may be semi-persistent or configured through scheduling request procedures. The MPR associated with the uplink transmission is based on an overlap between the time-frequency resource allocation and an I/Q image associated with the uplink transmission. The I/Q image may appear at a frequency symmetrically opposite to the desired signal frequency relative to an LO frequency, resulting from imperfections in the in-phase and quadrature signal paths of a transmitter at the UE 104-b.

At 608, the UE 104-b selects a maximum transmit power for the uplink transmission based on the MPR. The MPR varies according to the overlap between the time-frequency resource allocation and the I/Q image. If the resource allocation and the I/Q image do not overlap, then the UE 104-b may apply a lower MPR, enabling higher transmit power levels. If the resource allocation and the I/Q image partially overlap, then the UE 104-b may determine whether a number (e.g., numerical quantity, amount) of REs that overlap is less than a threshold. If the number of overlapping REs is less than the threshold, then the UE 104-b may apply the MPR for the no overlap case, otherwise the UE 104-b may apply the MPR for the overlap case. If the resource allocation and the I/Q image fully overlap, then the UE 104-b may apply a higher MPR to maintain signal quality and meet emission criterion. The uplink transmission may satisfy one or more emission criterion based on the MPR, including EVM, ACLR, SEM, spurious emission, or in-band emission criterion, among other example emission criterion. In some cases, the UE 104-b determines the MPR from the lookup table received at 602.

In some cases, at 610, to select the maximum transmit power, the UE 104-b determines the MPR based on the overlap between the time-frequency resource allocation and the I/Q image. The time-frequency resource allocation may include at least one of one or more first RBs that do not overlap with the I/Q image, one or more second RBs that partially overlap with the I/Q image, or one or more third RBs that overlap with the I/Q image. The overlap is based on a frequency corresponding to the LO. The UE 104-b may evaluate whether the resource allocation and the I/Q image are positioned on a same side or opposite sides of the LO frequency to determine the extent of overlap. The UE 104-b may define a no image interference region, in which resource allocations do not overlap with a corresponding I/Q image (e.g., when the resource allocation begins and ends on the same side of the LO). Respective MPRs of the set of MPRs in the lookup table correspond to the one or more first RBs, the one or more second RBs, or the one or more third RBs.

In some cases, at 612, the UE 104-b applies a higher order modulation scheme or type to the uplink transmission, such as a 64-QAM or 256-QAM modulation type. The UE 104-b may select the modulation scheme based on channel conditions, available transmit power after accounting for the MPR, and the target data rate for the uplink transmission. Additionally, or alternatively, the NE 102-b may indicate the modulation scheme to be applied through an MCS field in DCI, where the selection may account for the expected MPR reduction when the resource allocation falls within a no image interference region.

At 614, the UE 104-b transmits the uplink transmission to the NE 102-b using a transmit power that is based on the maximum transmit power. The transmit power is selected to be less than or equal to the maximum transmit power, accounting for the applicable MPR and other power control adjustments to ensure compliance with emission criterion, while maintaining threshold signal quality for successful data transmission. The uplink transmission may utilize the applied modulation type (e.g., a higher order modulation type, including 64-QAM or 256-QAM), enabling higher data rates when the MPR provides for increased transmit power levels.

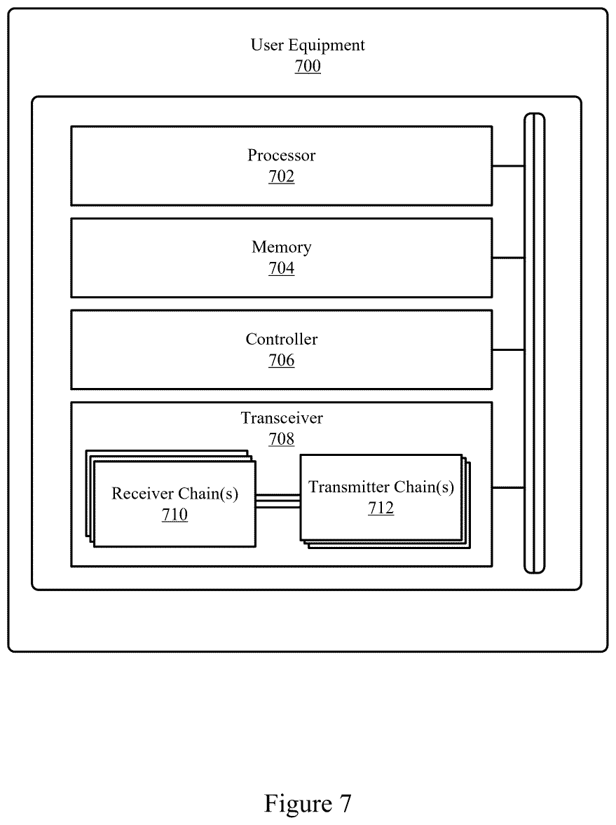

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field-programmable gate-array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving signaling that indicates a time-frequency resource allocation associated with an uplink transmission, where an MPR associated with the uplink transmission is based on an overlap between the time-frequency resource allocation and an I/Q image associated with the uplink transmission, selecting, based on the MPR, a maximum transmit power for the uplink transmission, and transmitting the uplink transmission using a transmit power that is based on the maximum transmit power.

Additionally, the UE 700 may be configured to or operable to support any one or combination of the uplink transmission satisfies one or more emission criterion based on the MPR, where the one or more emission criterion include one or more of an EVM, an ACLR, a SEM, a spurious emission, or an in-band emission. Additionally, or alternatively, the UE 700 may be configured to or operable to support an MCS corresponding to the time-frequency resource allocation is based on the MPR. Additionally, or alternatively, the UE 700 may be configured to or operable to support applying a modulation type to the uplink transmission, where the modulation type includes 64-QAM or 256-QAM. Additionally, or alternatively, the UE 700 may be configured to or operable to support the time-frequency resource allocation overlaps with the I/Q image based on a frequency corresponding to an LO, and the time-frequency resource allocation includes at least one of one or more first RBs that do not overlap with the I/Q image, one or more second RBs that partially overlap with the I/Q image, or one or more third RBs that overlap with the I/Q image. Additionally, or alternatively, the UE 700 may be configured to or operable to support receiving additional signaling that indicates at least one lookup table including a set of MPRs including the MPR, where respective MPRs of the set of MPRs correspond to the one or more first RBs, the one or more second RBs, or the one or more third RBs. Additionally, or alternatively, the UE 700 may be configured to or operable to support the time-frequency resource allocation includes at least one of inner RBs, outer RBs, or edge RBs.

Additionally, or alternatively, the UE 700 may be configured to or operable to support receiving additional signaling that indicates an update to a frequency corresponding to an LO, and adjusting, based on the update to the frequency corresponding to the LO, the frequency corresponding to the LO to reduce the overlap between the time-frequency resource allocation and the I/Q image. Additionally, or alternatively, the UE 700 may be configured to or operable to support transmitting additional signaling that indicates a frequency corresponding to an LO, where the time-frequency resource allocation overlaps with the I/Q image based on the frequency corresponding to the LO, and the time-frequency resource allocation is based on reducing the overlap between the time-frequency resource allocation and the I/Q image.

Additionally, or alternatively, the UE 700 may support at least one memory (e.g., the memory 704) and at least one processor (e.g., the processor 702) coupled with the at least one memory and configured to or operable to cause the UE to receive signaling that indicates a time-frequency resource allocation associated with an uplink transmission, where an MPR associated with the uplink transmission is based on an overlap between the time-frequency resource allocation and an I/Q image associated with the uplink transmission, select, based on the MPR, a maximum transmit power for the uplink transmission, and transmit the uplink transmission using a transmit power that is based on the maximum transmit power.

Additionally, the UE 700 may be configured to or operable to support any one or combination of the uplink transmission satisfies one or more emission criterion based on the MPR, where the one or more emission criterion include one or more of an EVM, an ACLR, a SEM, a spurious emission, or an in-band emission. Additionally, or alternatively, the UE 700 may be configured to or operable to support an MCS corresponding to the time-frequency resource allocation is based on the MPR. Additionally, or alternatively, to transmit the uplink transmission, the UE 700 may be configured to or operable to support to apply a modulation type to the uplink transmission, where the modulation type includes 64-QAM or 256-QAM. Additionally, or alternatively, the UE 700 may be configured to or operable to support the time-frequency resource allocation overlaps with the I/Q image based on a frequency corresponding to an LO, and the time-frequency resource allocation includes at least one of one or more first RBs that do not overlap with the I/Q image, one or more second RBs that partially overlap with the I/Q image, or one or more third RBs that overlap with the I/Q image. Additionally, or alternatively, the UE 700 may be configured to or operable to support to receive additional signaling that indicates at least one lookup table including a set of MPRs including the MPR, where respective MPRs of the set of MPRs correspond to the one or more first RBs, the one or more second RBs, or the one or more third RBs. Additionally, or alternatively, the UE 700 may be configured to or operable to support the time-frequency resource allocation includes at least one of inner RBs, outer RBs, or edge RBs.

Additionally, or alternatively, the UE 700 may be configured to or operable to support to receive additional signaling that indicates an update to a frequency corresponding to an LO, and adjust, based on the update to the frequency corresponding to the LO, the frequency corresponding to the LO to reduce the overlap between the time-frequency resource allocation and the I/Q image. Additionally, or alternatively, the UE 700 may be configured to or operable to support to transmit additional signaling that indicates a frequency corresponding to an LO, where the time-frequency resource allocation overlaps with the I/Q image based on the frequency corresponding to the LO, and the time-frequency resource allocation is based on reducing the overlap between the time-frequency resource allocation and the I/Q image.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes, like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

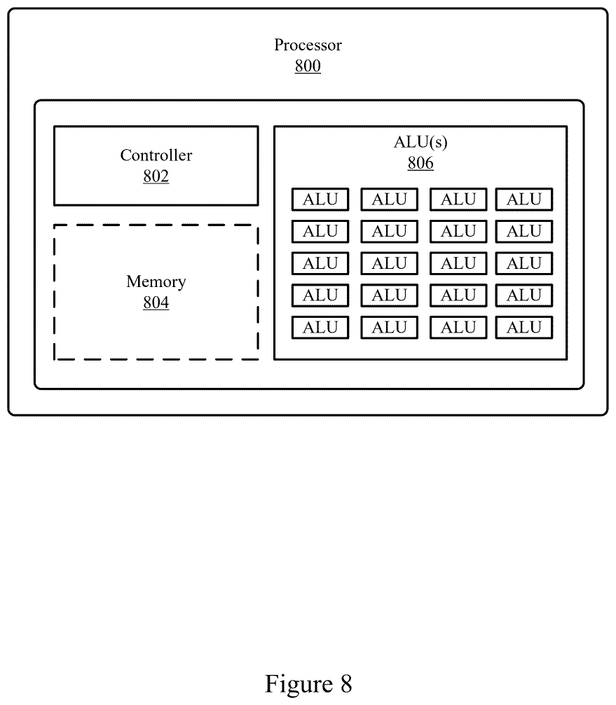

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may be configured to or operable to support at least one controller (e.g., the controller 802) coupled with at least one memory (e.g., the memory 804) and configured to cause the processor to receive signaling that indicates a time-frequency resource allocation associated with an uplink transmission, where an MPR associated with the uplink transmission is based on an overlap between the time-frequency resource allocation and an I/Q image associated with the uplink transmission, select, based on the MPR, a maximum transmit power for the uplink transmission, and transmit the uplink transmission using a transmit power that is based on the maximum transmit power.

Additionally, the processor 800 may be configured to or operable to support any one or combination of the uplink transmission satisfies one or more emission criterion based on the MPR, where the one or more emission criterion include one or more of an EVM, an ACLR, a SEM, a spurious emission, or an in-band emission. Additionally, or alternatively, the processor 800 may be configured to or operable to support an MCS corresponding to the time-frequency resource allocation is based on the MPR. Additionally, or alternatively, the processor 800 may be configured to or operable to support to apply a modulation type to the uplink transmission, where the modulation type includes 64-QAM or 256-QAM. Additionally, or alternatively, the processor 800 may be configured to or operable to support the time-frequency resource allocation overlaps with the I/Q image based on a frequency corresponding to an LO, and the time-frequency resource allocation includes at least one of one or more first RBs that do not overlap with the I/Q image, one or more second RBs that partially overlap with the I/Q image, or one or more third RBs that overlap with the I/Q image. Additionally, or alternatively, the processor 800 may be configured to or operable to support to receive additional signaling that indicates at least one lookup table including a set of MPRs including the MPR, where respective MPRs of the set of MPRs correspond to the one or more first RBs, the one or more second RBs, or the one or more third RBs. Additionally, or alternatively, the processor 800 may be configured to or operable to support the time-frequency resource allocation includes at least one of inner RBs, outer RBs, or edge RBs.

Additionally, or alternatively, the processor 800 may be configured to or operable to support to receive additional signaling that indicates an update to a frequency corresponding to an LO, and adjust, based on the update to the frequency corresponding to the LO, the frequency corresponding to the LO to reduce the overlap between the time-frequency resource allocation and the I/Q image. Additionally, or alternatively, the processor 800 may be configured to or operable to support to transmit additional signaling that indicates a frequency corresponding to an LO, where the time-frequency resource allocation overlaps with the I/Q image based on the frequency corresponding to the LO, and the time-frequency resource allocation is based on reducing the overlap between the time-frequency resource allocation and the I/Q image.

The processor 800 may be configured to or operable to support at least one controller (e.g., the controller 802) coupled with at least one memory (e.g., the memory 804) and configured to cause the processor to transmit signaling that indicates a time-frequency resource allocation associated with an uplink transmission, where an MPR associated with the uplink transmission is based on an overlap between the time-frequency resource allocation and an I/Q image associated with the uplink transmission, and receive the uplink transmission using a transmit power that is based on a maximum transmit power, where the maximum transmit power is based on the MPR.

Additionally, the processor 800 may be configured to or operable to support any one or combination of the uplink transmission satisfies one or more emission criterion based on the MPR, where the one or more emission criterion include one or more of an EVM, an ACLR, a SEM, a spurious emission, or an in-band emission. Additionally, or alternatively, the processor 800 may be configured to or operable to support to select an MCS corresponding to the time-frequency resource allocation based on the MPR. Additionally, or alternatively, the processor 800 may be configured to or operable to support the uplink transmission is associated with a modulation type, and the modulation type includes 64-QAM or 256-QAM. Additionally, or alternatively, the processor 800 may be configured to or operable to support the time-frequency resource allocation overlaps with the I/Q image based on a frequency corresponding to an LO, and the time-frequency resource allocation includes at least one of one or more first RBs that do not overlap with the I/Q image, one or more second RBs that partially overlap with the I/Q image, or one or more third RBs that overlap with the I/Q image. Additionally, or alternatively, the processor 800 may be configured to or operable to support to transmit additional signaling that indicates at least one lookup table including a set of MPRs including the MPR, where respective MPRs of the set of MPRs correspond to the one or more first RBs, the one or more second RBs, or the one or more third RBs. Additionally, or alternatively, the processor 800 may be configured to or operable to support the time-frequency resource allocation includes at least one of inner RBs, outer RBs, or edge RBs.

Additionally, or alternatively, the processor 800 may be configured to or operable to support to transmit additional signaling that indicates an update to a frequency corresponding to an LO to reduce the overlap between the time-frequency resource allocation and the I/Q image. Additionally, or alternatively, the processor 800 may be configured to or operable to support to receive additional signaling that indicates a frequency corresponding to an LO, where the time-frequency resource allocation overlaps with the I/Q image based on the frequency corresponding to the LO, and select the time-frequency resource allocation based on reducing the overlap between the time-frequency resource allocation and the I/Q image.

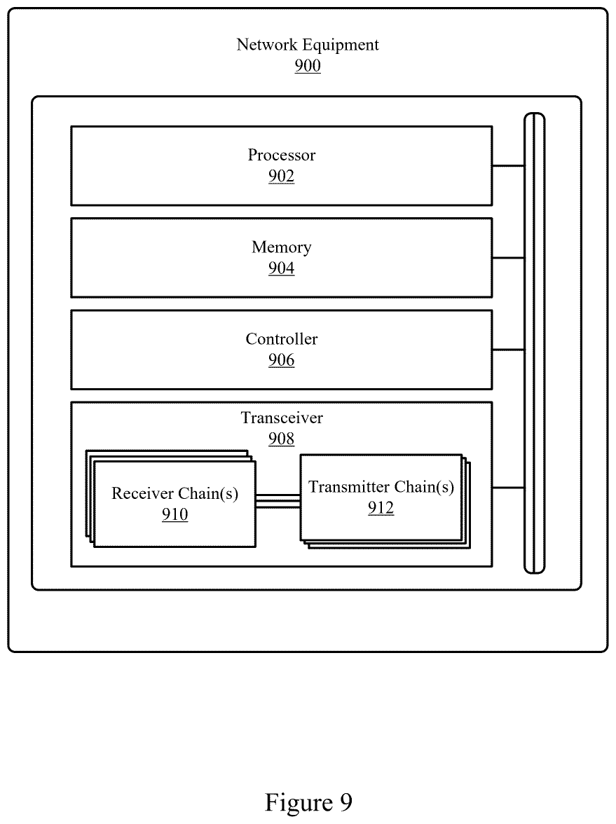

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting signaling that indicates a time-frequency resource allocation associated with an uplink transmission, where an MPR associated with the uplink transmission is based on an overlap between the time-frequency resource allocation and an I/Q image associated with the uplink transmission, and receiving the uplink transmission using a transmit power that is based on a maximum transmit power, where the maximum transmit power is based on the MPR.

Additionally, the NE 900 may be configured to or operable to support any one or combination of the uplink transmission satisfies one or more emission criterion based on the MPR, where the one or more emission criterion include one or more of an EVM, an ACLR, a SEM, a spurious emission, or an in-band emission. Additionally, or alternatively, the NE 900 may be configured to or operable to support selecting an MCS corresponding to the time-frequency resource allocation based on the MPR. Additionally, or alternatively, the NE 900 may be configured to or operable to support the uplink transmission is associated with a modulation type, and the modulation type includes 64-QAM or 256-QAM. Additionally, or alternatively, the NE 900 may be configured to or operable to support the time-frequency resource allocation overlaps with the I/Q image based on a frequency corresponding to an LO, and the time-frequency resource allocation includes at least one of one or more first RBs that do not overlap with the I/Q image, one or more second RBs that partially overlap with the I/Q image, or one or more third RBs that overlap with the I/Q image. Additionally, or alternatively, the NE 900 may be configured to or operable to support transmitting additional signaling that indicates at least one lookup table including a set of MPRs including the MPR, where respective MPRs of the set of MPRs correspond to the one or more first RBs, the one or more second RBs, or the one or more third RBs. Additionally, or alternatively, the NE 900 may be configured to or operable to support the time-frequency resource allocation includes at least one of inner RBs, outer RBs, or edge RBs.

Additionally, or alternatively, the NE 900 may be configured to or operable to support transmitting additional signaling that indicates an update to a frequency corresponding to an LO to reduce the overlap between the time-frequency resource allocation and the I/Q image. Additionally, or alternatively, the NE 900 may be configured to or operable to support receiving additional signaling that indicates a frequency corresponding to an LO, where the time-frequency resource allocation overlaps with the I/Q image based on the frequency corresponding to the LO, and select the time-frequency resource allocation based on reducing the overlap between the time-frequency resource allocation and the I/Q image.

Additionally, or alternatively, the NE 900 may support at least one memory (e.g., the memory 904) and at least one processor (e.g., the processor 902) coupled with the at least one memory and configured or operable to cause the NE to transmit signaling that indicates a time-frequency resource allocation associated with an uplink transmission, where an MPR associated with the uplink transmission is based on an overlap between the time-frequency resource allocation and an I/Q image associated with the uplink transmission, and receive the uplink transmission using a transmit power that is based on a maximum transmit power, where the maximum transmit power is based on the MPR.

Additionally, the NE 900 may be configured to or operable to support any one or combination of the uplink transmission satisfies one or more emission criterion based on the MPR, where the one or more emission criterion include one or more of an EVM, an ACLR, a SEM, a spurious emission, or an in-band emission. Additionally, or alternatively, the NE 900 may be configured to or operable to support to select an MCS corresponding to the time-frequency resource allocation based on the MPR. Additionally, or alternatively, the NE 900 may be configured to or operable to support the uplink transmission is associated with a modulation type, and the modulation type includes 64-QAM or 256-QAM. Additionally, or alternatively, the NE 900 may be configured to or operable to support the time-frequency resource allocation overlaps with the I/Q image based on a frequency corresponding to an LO, and the time-frequency resource allocation includes at least one of one or more first RBs that do not overlap with the I/Q image, one or more second RBs that partially overlap with the I/Q image, or one or more third RBs that overlap with the I/Q image. Additionally, or alternatively, the NE 900 may be configured to or operable to support to transmit additional signaling that indicates at least one lookup table including a set of MPRs including the MPR, where respective MPRs of the set of MPRs correspond to the one or more first RBs, the one or more second RBs, or the one or more third RBs. Additionally, or alternatively, the NE 900 may be configured to or operable to support the time-frequency resource allocation includes at least one of inner RBs, outer RBs, or edge RBs.

Additionally, or alternatively, the NE 900 may be configured to or operable to support to transmit additional signaling that indicates an update to a frequency corresponding to an LO to reduce the overlap between the time-frequency resource allocation and the I/Q image. Additionally, or alternatively, the NE 900 may be configured to or operable to support to receive additional signaling that indicates a frequency corresponding to an LO, where the time-frequency resource allocation overlaps with the I/Q image based on the frequency corresponding to the LO, and select the time-frequency resource allocation based on reducing the overlap between the time-frequency resource allocation and the I/Q image.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., an LNA) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

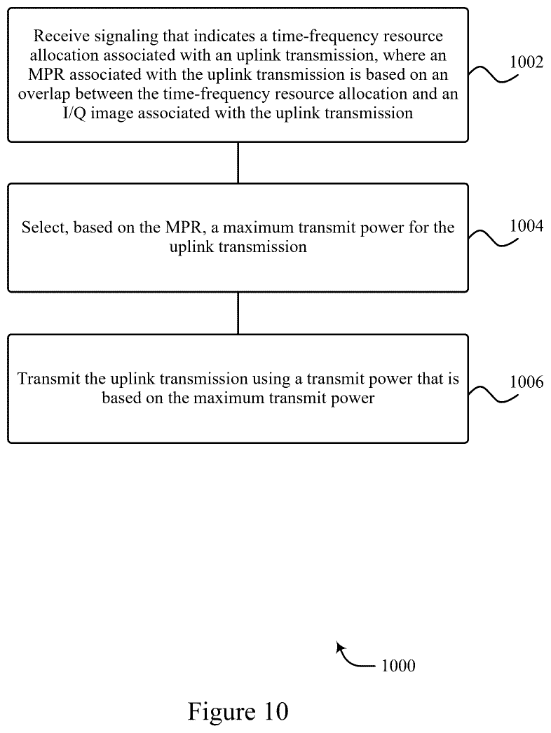

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving signaling that indicates a time-frequency resource allocation associated with an uplink transmission, where an MPR associated with the uplink transmission is based on an overlap between the time-frequency resource allocation and an I/Q image associated with the uplink transmission. The operations of 1002 may be performed in accordance with examples as described herein. In some implementations, aspects of the operations of 1002 may be performed by a UE as described with reference to FIG. 7.

At 1004, the method may include selecting, based on the MPR, a maximum transmit power for the uplink transmission. The operations of 1004 may be performed in accordance with examples as described herein. In some implementations, aspects of the operations of 1004 may be performed by a UE as described with reference to FIG. 7.

At 1006, the method may include transmitting the uplink transmission using a transmit power that is based on the maximum transmit power. The operations of 1006 may be performed in accordance with examples as described herein. In some implementations, aspects of the operations of 1006 may be performed a UE as described with reference to FIG. 7.

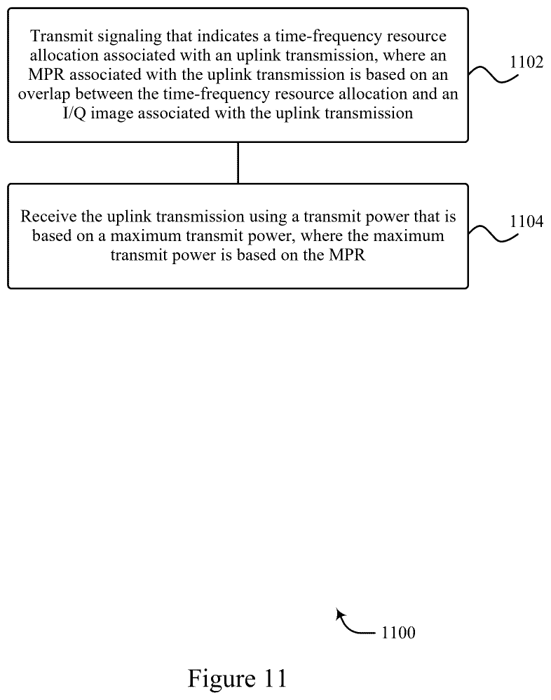

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting signaling that indicates a time-frequency resource allocation associated with an uplink transmission, where an MPR associated with the uplink transmission is based on an overlap between the time-frequency resource allocation and an I/Q image associated with the uplink transmission. The operations of 1102 may be performed in accordance with examples as described herein. In some implementations, aspects of the operations of 1102 may be performed by an NE as described with reference to FIG. 9.

At 1104, the method may include receiving the uplink transmission using a transmit power that is based on a maximum transmit power, where the maximum transmit power is based on the MPR. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a time-frequency resource allocation associated with an uplink transmission, wherein a maximum power reduction (MPR) associated with the uplink transmission is based at least in part on an overlap between the time-frequency resource allocation and an in-phase/quadrature (I/Q) image associated with the uplink transmission;
select, based at least in part on the MPR, a maximum transmit power for the uplink transmission; and
transmit the uplink transmission using a transmit power that is based at least in part on the maximum transmit power.

2. The UE of claim 1, wherein the uplink transmission satisfies one or more emission criterion based at least in part on the MPR, and wherein the one or more emission criterion comprise one or more of an error vector magnitude (EVM), an adjacent channel leakage ratio (ACLR), a spectral emissions mask (SEM), a spurious emission, or an in-band emission.

3. The UE of claim 1, wherein a modulation and coding scheme (MCS) corresponding to the time-frequency resource allocation is based at least in part on the MPR.

4. The UE of claim 1, wherein to transmit the uplink transmission, the at least one processor is further operable to cause the UE to apply a modulation type to the uplink transmission, wherein the modulation type comprises 64-quadrature amplitude modulation (QAM) or 256-QAM.

5. The UE of claim 1, wherein the time-frequency resource allocation overlaps with the I/Q image based at least in part on a frequency corresponding to a local oscillator (LO), and wherein the time-frequency resource allocation comprises at least one of one or more first resource blocks (RBs) that do not overlap with the I/Q image, one or more second RBs that partially overlap with the I/Q image, or one or more third RBs that overlap with the I/Q image.

6. The UE of claim 5, wherein the at least one processor is further operable to cause the UE to receive additional signaling that indicates at least one lookup table comprising a plurality of MPRs comprising the MPR, wherein respective MPRs of the plurality of MPRs correspond to the one or more first RBs, the one or more second RBs, or the one or more third RBs.

7. The UE of claim 1, wherein the time-frequency resource allocation comprises at least one of inner RBs, outer RBs, or edge RBs.

8. The UE of claim 1, wherein the at least one processor is further operable to cause the UE to:
receive additional signaling that indicates an update to a frequency corresponding to a local oscillator (LO); and
adjust, based at least in part on the update to the frequency corresponding to the LO, the frequency corresponding to the LO to reduce the overlap between the time-frequency resource allocation and the I/Q image.

9. The UE of claim 1, wherein the at least one processor is further operable to cause the UE to transmit additional signaling that indicates a frequency corresponding to a local oscillator (LO), wherein the time-frequency resource allocation overlaps with the I/Q image based at least in part on the frequency corresponding to the LO, and wherein the time-frequency resource allocation is based at least in part on reducing the overlap between the time-frequency resource allocation and the I/Q image.

10. A method performed by a user equipment (UE), the method comprising:
receiving signaling that indicates a time-frequency resource allocation associated with an uplink transmission, wherein a maximum power reduction (MPR) associated with the uplink transmission is based at least in part on an overlap between the time-frequency resource allocation and an in-phase/quadrature (I/Q) image associated with the uplink transmission;
selecting, based at least in part on the MPR, a maximum transmit power for the uplink transmission; and
transmitting the uplink transmission using a transmit power that is based at least in part on the maximum transmit power.

11. A network equipment (NE) for wireless communication, comprising:
at least one memory; and
at least one processor coupled with the at least one memory and operable to cause the NE to:
transmit signaling that indicates a time-frequency resource allocation associated with an uplink transmission, wherein a maximum power reduction (MPR) associated with the uplink transmission is based at least in part on an overlap between the time-frequency resource allocation and an in-phase/quadrature (I/Q) image associated with the uplink transmission; and
receive the uplink transmission using a transmit power that is based at least in part on a maximum transmit power, wherein the maximum transmit power is based at least in part on the MPR.

12. The NE of claim 11, wherein the uplink transmission satisfies one or more emission criterion based at least in part on the MPR, and wherein the one or more emission criterion comprise one or more of an error vector magnitude (EVM), an adjacent channel leakage ratio (ACLR), a spectral emissions mask (SEM), a spurious emission, or an in-band emission.

13. The NE of claim 11, wherein the at least one processor is further operable to cause the NE to select a modulation and coding scheme (MCS) corresponding to the time-frequency resource allocation based at least in part on the MPR.

14. The NE of claim 11, wherein the uplink transmission is associated with a modulation type, and wherein the modulation type comprises 64-quadrature amplitude modulation (QAM) or 256-QAM.

15. The NE of claim 11, wherein the time-frequency resource allocation overlaps with the I/Q image based at least in part on a frequency corresponding to a local oscillator (LO), and wherein the time-frequency resource allocation comprises at least one of one or more first resource blocks (RBs) that do not overlap with the I/Q image, one or more second RBs that partially overlap with the I/Q image, or one or more third RBs that overlap with the I/Q image.

16. The NE of claim 15, wherein the at least one processor is further operable to cause the NE to transmit additional signaling that indicates at least one lookup table comprising a plurality of MPRs comprising the MPR, wherein respective MPRs of the plurality of MPRs correspond to the one or more first RBs, the one or more second RBs, or the one or more third RBs.

17. The NE of claim 11, wherein the time-frequency resource allocation comprises at least one of inner RBs, outer RBs, or edge RBs.

18. The NE of claim 11, wherein the at least one processor is further operable to cause the NE to transmit additional signaling that indicates an update to a frequency corresponding to a local oscillator (LO) to reduce the overlap between the time-frequency resource allocation and the I/Q image.

19. The NE of claim 11, wherein to transmit the signaling, the at least one processor is operable to cause the NE to:
receive additional signaling that indicates a frequency corresponding to a local oscillator (LO), wherein the time-frequency resource allocation overlaps with the I/Q image based at least in part on the frequency corresponding to the LO; and
select the time-frequency resource allocation based at least in part on reducing the overlap between the time-frequency resource allocation and the I/Q image.

20. A network equipment (NE) for wireless communication, comprising:
at least one memory; and
at least one processor coupled with the at least one memory and operable to cause the NE to:
transmit signaling that indicates a time-frequency resource allocation associated with an uplink transmission, wherein a maximum power reduction (MPR) associated with the uplink transmission is based at least in part on an overlap between the time-frequency resource allocation and an in-phase/quadrature (I/Q) image associated with the uplink transmission; and
receive the uplink transmission using a transmit power that is based at least in part on a maximum transmit power, wherein the maximum transmit power is based at least in part on the MPR.
